(19) United States
(12) Patent Application Publication
(10) Pub. No.: US 2016/0041981 A1
(43) Pub. Date: Feb. 11, 2016

(54) ENHANCED CASCADED OBJECT-RELATED CONTENT PROVISION SYSTEM AND METHOD

(71) Applicant: EYEDUCATION A.Y. LTD., NEVE ATIV (IL)

(72) Inventors: ARIE BEN ZVI, NEVE ATIV (IL); MARK PEISACHOVICH, ASHQELON (IL); SAGI RORLICH, TEL-AVIV (IL); RONNY REMESNIK, ASHDOD (IL)

(21) Appl. No.: 14/844,485

(22) Filed: Sep. 3, 2015

Related U.S. Application Data
(63) Continuation of application No. PCT/IL2014/000015, filed on Mar. 4, 2014.
(60) Provisional application No. 61/773,882, filed on Mar. 7, 2013.
(60) Provisional application No. 61/844,887, filed on Jul. 11, 2013.

(51) Int. Cl. G06F 17/30

(52) U.S. Cl. CPC G06F 17/30047; G06F 17/30041; G06F 17/30867; G06F 17/3087

(57) ABSTRACT

The present invention provides systems and methods for enhanced cascaded object-related content provision, the method including detecting an object with a multimedia communication device, uploading content related to the detected object to the device to enable a user to perform at least one user action and providing further content associated with the detected object responsive to at least one of a device location, object detection and the at least one user action.

### FIELD OF THE INVENTION

The present invention relates generally to apparatus and methods for dynamic searching for content, and more specifically to apparatus and methods for real-time enhanced local and distant content searching, as well as to apparatus and methods for real-time enhanced local and distant content provision, associated with a detected object.

### BACKGROUND OF THE INVENTION

Vision systems can also be used to capture images which are then used as an input to another system, for example scanning an image, compare to a database and then display the image on a mobile terminal along with a fixed number of options one can do with this image is known in the industry.

Portable communication devices such as cell phones are currently able to connect to the internet and enable their users to perform searches for content.

Some patent publications in the field include US2010046842, which discloses cell phones and other portable devices, which are equipped with a variety of technologies by which existing functionality can be improved, and new functionality can be provided. Some relate to visual search capabilities, and determining appropriate actions responsive to different image inputs. Others relate to processing of image data. Still others concern metadata generation, processing, and representation. Yet others relate to coping with fixed focus limitations of cell phone cameras, e.g., in reading digital watermark data. Still others concern user interface improvements. A great number of other features and arrangements are also detailed.

WO12120108A2 discloses a method to enhance broadcast content of an event received by a television set by supplying additional information related to the event. A user builds a request message for getting more information through a displayed menu where some items are extracted from metadata broadcast with the content. The request message, completed with user preference and identification data, is sent to a management center. The latter performs a search in local databases or in remote databases of providers distributed in a cloud comprising a plurality of internet services and resources. The search results are filtered before sending to the television set in form of enhanced data comprising abstracts including at least text, or any combination of text with graphics or pictures.

DE102004061841A describes a system, which has a mixing system for simultaneous display of a video image and a three-dimensional data model, a definition system for defining search spaces in the video image, a search system for searching for features in the camera image, an allocation system for allocating features in the camera image to features in the data model and a position determination system for determining the camera position. The search space for features in the camera image can be restricted by the user by manipulating a three-dimensional data model.

US2012081529A describes a method for generating and reproducing moving image data by using augmented reality (AR) and a photographing apparatus using the method includes features of capturing a moving image, receiving augmented reality information (ARI) of the moving image, and generating a file including the ARI while simultaneously recording the captured moving image. Accordingly, when moving image data is recorded, an ARI file including ARI is also generated, thereby providing an environment in which the ARI is usable when reproducing the recorded moving image data.

US2012079426A discloses a game apparatus obtains a real world image, taken with an imaging device, and detects a marker from the real world image. The game apparatus calculates a relative position of the imaging device and the marker on the basis of the detection result of the marker, and sets a virtual camera in a virtual space on the basis of the calculation result. The game apparatus locates a selection object that is associated with a menu item selectable by a user and is to be selected by the user, as a virtual object at a predetermined position in the virtual space that is based on the position of the marker. The game apparatus takes an image of the virtual space with the virtual camera, generates an object image of the selection object, and generates a superimposed image in which the object image is superimposed on the real world image. Thus, there remains a need for improved systems and methods for finding and receiving object-associated content using a mobile communication device.

### SUMMARY OF THE INVENTION

It is an object of some aspects of the present invention to provide apparatus and methods for dynamic content searching.

It is another object of some aspects of the present invention to provide software products for dynamic content searching.

It is another object of some further aspects of the present invention to provide portable communication apparatus and methods for simultaneous local and distant content searching.

It is another object of some further aspects of the present invention to provide portable communication apparatus and methods for simultaneous local and distant content downloading.

It is an object of some aspects of the present invention to provide apparatus and methods for dynamic object-related content provision systems and methods.

It is another object of some aspects of the present invention to provide software products for object-related content provision systems and methods.

It is another object of some further aspects of the present invention to provide portable communication apparatus and methods for enhanced object-related content provision systems and methods.

It is another object of some further aspects of the present invention to provide portable communication apparatus and methods for enhanced cascaded object-related content provision systems and methods.

It is another object of some further aspects of the present invention to provide portable communication apparatus and methods for simultaneous local and distant object-associated content downloading.

It is another object of some further aspects of the present invention to provide a cell phone application, which is constructed and configured to detect objects and make them interactive by playing multimedia video and audio outputs.

Once a person using the application points any camera, be it smart phone or tablet to an object, the application will recognize the image and play the matching interactive content.

According to some aspects of the present invention, there is provided a system for enhanced cascaded object-related content provision. The system is constructed and configured to provide a user with content on a mobile communication device, a personal computer or communication apparatus. The system allows content to be inputted and updated, and then takes in to consideration which content should be presented based upon at least one of a user profile and user location, historical user preferences, user geographic location, time of day, age, motion, and past events. The system is constructed and configured to use the historic user data, for example, how the viewer has chosen to view content in the past (i.e., story, video, augmented reality), content which has they have recently viewed, and other factors into account in deciding on which new content/form of content is to presented to a specific user.

There is thus provided according to an embodiment of the present invention, a method for enhanced cascaded object-related content provision, the method including;
i. detecting an object with a multimedia communication device;
ii. uploading content related to the detected object to said device to enable a user to perform at least one user action; and
iii. providing further content associated with said detected object responsive to at least one of object detection, device location and said at least one user action.

Moreover, according to an embodiment of the present invention, the enhanced cascade object-related content provision is responsive to two user actions.

Additionally, according to an embodiment of the present invention, the enhanced cascade object-related content provision is responsive to three user actions. Importantly, the enhanced cascade object-related content provision is provided according to a predefined sequence.

According to some embodiments the predefined sequence is associated with at least one of the detected object, a location of the device and a user characteristic.

Additionally, according to an embodiment of the present invention, the method further includes, generating networked content associated with said detected object to form a storable networked content package associated with the object;

Furthermore, according to an embodiment of the present invention, the method further includes locally downloading an identified-object multimedia package including at least one of local content and the networked content package associated with the identified object(s).

There is thus provided according to an embodiment of the present invention, a networked system for enhanced cascaded object-related content provision, the system including;
i. a communication network;
ii. a processor; and
iii. a multimedia communication device adapted to detect an object and to upload content to a display on said device related to the detected object to enable a user to perform at least one user action, wherein said device is further adapted to provide further content associated with said detected object responsive to said at least one user action.

Additionally, according to an embodiment of the present invention, the processor is adapted to;
a. generate content associated with an object and to store the content in a database; and
b. dynamically adjust the content associated with the object according to at least one of a user profile and user location to form a user-defined object-based content package;

Furthermore, according to an embodiment of the present invention the multimedia communication device further includes;
i. an optical element adapted to capture a plurality of images of captured objects;
ii. a processing device adapted to;
   1. activate an object recognition algorithm to detect at least one detected object from the plurality of images of captured objects by performing a local search and a networked search for at least one object simultaneously;
   2. download at least one of local content and networked content to form a downloaded multimedia package; and
iii. a display adapted to display at least one captured image of the identified object(s) and provide at least one of user-defined object-based content and the downloaded multimedia package.

There is thus provided according to an embodiment of the present invention, a computer software product, the product configured for enhanced cascaded object-related content provision, the product including a computer-readable medium in which program instructions are stored, which instructions, when read by a computer, cause the computer to;
i. detect an object with a multimedia communication device;
ii. upload content related to the detected object to said device to enable a user to perform at least one user action; and
iii. provide further content associated with said detected object responsive to at least one of the device location, object detection and said at least one user action.
   Furthermore, according to an embodiment of the present invention, the software product is further adapted to:
a. generate networked content associated with an object to form a storable networked content package associated with the object;
b. capture a plurality of images of captured objects;
c. activate an object recognition algorithm to detect at least one identified object from the plurality of images of captured objects by performing a local search and a networked search for the at least one object simultaneously; and
d. download a detected-object multimedia package including at least one of local content and the networked content package associated with the detected object(s).

According to some aspects of the present invention, there is provided a system of simultaneous local and cloud content searching. There is thus provided according to an embodiment of the present invention, a networked system for simultaneous local and cloud content searching, the system including;
a. a processing element adapted to;
   i. generate content associated with an object and to store the content in a database; and
   ii. dynamically adjust the content associated with the object according to at least one of a user profile and user location to form a user-defined object-based content package;
b. a multimedia communication device associated with the user, the device including;
   i. an optical element adapted to capture a plurality of images of captured objects;
   ii. a processing device adapted to;
      1. activate an object recognition algorithm to detect at least one identified object from the plurality of images of captured objects by performing a local search and a networked search for the at least one object simultaneously;
      2. download at least one of local content and networked content to form a downloaded multimedia package; and
iii. a display adapted to display at least one captured image of the identified object(s) and provide at least one of user-defined object-based content and the downloaded multimedia package.

There is thus provided according to an embodiment of the present invention, a method for simultaneous local and cloud content searching, the method including;
i. generating networked content associated with an object to form a storable networked content package associated with the object;
ii. locally capturing a plurality of images of captured objects;
iii. activating an object recognition algorithm to detect at least one identified object from the plurality of images of captured objects by performing a local search and a networked search for the at least one object simultaneously; and
iv. locally downloading an identified-object multimedia package including at least one of local content and the networked content package associated with the identified object(s).

There is thus provided according to an embodiment of the present invention, a computer software product, the product configured for simultaneous local and cloud content searching, the product including a computer-readable medium in which program instructions are stored, which instructions, when read by a computer, cause the computer to;
i. generate networked content associated with an object to form a storable networked content package associated with the object;
ii. capture a plurality of images of captured objects;
iii. activate an object recognition algorithm to detect at least one identified object from the plurality of images of captured objects by performing a local search and a networked search for the at least one object simultaneously; and
iv. download an identified-object multimedia package including at least one of local content and the networked content package associated with the identified object(s).

Further embodiments of the present invention provide for providing dynamic user-defined content searching. The system generates a plurality of content associated packages (named titles) with specific objects and stores these in a database. When a user device captures one such object, whether it is an image, or audio fingerprint, the system is constructed and configured to upload a title associated with the object onto the user's communication device. In some cases, the titles may be preloaded on the user's communication device. The system is further constructed and configured to dynamically adapt and change the titles according to at least one of the specific user profile and user location.

Some/further embodiments of the present invention provide an object, which may be associated with multiple content associated packages (titles). When a user device captures one such object, whether it is an image or audio fingerprint, the system is constructed and configured to upload a title associated with the object onto the user's communication device, The system may select the title from a multiple titles associated with the object, according to at least one of the specific user profile and user location.

Some embodiments of the present invention provide a method of connecting between images, sounds and movements to multimedia expressions using a multimedia apparatus that receives image, sound and movement inputs, processes the received data and outputs voice or visual message or kinesthetic messages (i.e., vibration, buzzing, etc.) for the purpose of education, entertainment, advertisement, medical and commercial.

Some further embodiments of the present invention provide object detection recognition and tracking software, which is based on object features data. The object features data contains the data needed for an apparatus processing algorithm to detect and recognize the object.

The present invention further provides a method of preparing and relating between object images, object features data, multimedia video and audio expressions. An apparatus application recognizes the object and issues the related multimedia expressions.

Additionally, according to an embodiment of the present invention, the device further includes an audio output element for outputting audio received from the system.

Additionally, according to an embodiment of the present invention, the audio output element is adapted to output audio object-associated content simultaneously with the at least one captured object image so as to provide the dynamic content. In some cases, the dynamic content is user-matched content.

Furthermore, according to an embodiment of the present invention, the title content generator is adapted to form at least one title associated with the at least one identified object. According to some embodiments, the title is typically generated on a computer or processing device in the system. The title may be stored in a database in the system over a period of time. Thereafter, at any suitable time, it may be uploaded onto a user device. Additionally or alternatively, it may be updated or generated on a user device.

Furthermore, according to an embodiment of the present invention, a title may be associated to at least one or more objects.

Furthermore, according to an embodiment of the present invention, an object may be associated to at least one or more titles.

Moreover, according to an embodiment of the present invention, a display is adapted to display at least some visual content associated with the title with the captured object image.

The display may be separate from the processing device, the detection on one device and display the output on another device. For example one may use a mobile device and a television screen. The object detection can be within the mobile device and the multimedia output can be on the large television screen. The multimedia output on the larger screen may or may not be the same image as displayed on the mobile device.

Further, according to an embodiment of the present invention, the at least some visual content is interactive content.

Additionally, according to an embodiment of the present invention, the interactive content includes a visual menu and/or visual marker.

Moreover, according to an embodiment of the present invention, wherein the portable communications device further includes a motion sensor for motion detection.

Further, according to an embodiment of the present invention, the portable communications device is selected from the group consisting of a cellular phone, a Personal Computer (PC), a mobile phone, a mobile device, a computer, a speaker set, a television and a tablet computer.

According to a further embodiment of the present invention, the optical device is selected from the group consisting of a camera, a video camera, a Video stream, a CCD and CMOS image sensor and an image sensor.

Additionally, according to an embodiment of the present invention, the system further includes title management apparatus configured to filter the object-associated content according to at least one of a user profile and user location and to output personalized object-associated content in accordance with at least one of the user profile and user location.

Furthermore, according to an embodiment of the present invention, the captured objects are selected from the group consisting of an object in the vicinity of the device; an object in a printed article; an image on a still display of a device; an object in a video display, a text, a number, a marker, a cylindrical object, a two-dimensional (2D) object and a three-dimensional (3D) object.

Moreover, according to an embodiment of the present invention, the method further includes forming at least one title associated with the at least one identified object.

Additionally, according to an embodiment of the present invention, the displaying step further includes displaying at least some visual content, or producing audio content, or producing a kinesthetic output associated with the title of the captured object image.

Furthermore, according to an embodiment of the present invention, the at least some visual content is interactive content.

Additionally, according to an embodiment of the present invention, the interactive content includes a visual menu, a marker, which may be fixed or one which dynamically changes based upon user profiles and user locations.

Yet further, according to an embodiment of the present invention, the method further includes filtering the object-associated content according to a user profile and user location and to output personalized object-associated content in accordance with the user profile and user location.

The present invention further provides apparatus and methods for displaying a “title”.

By “title” is meant, according to the present invention, a group of data associated with an object and/or multiple objects, the title comprising an icon, information, a set of objects images, object features data, sounds, sound features data, movements, and movements features data. and a set of multimedia expressions comprising video, audio, text, PDF, images, Weblinks, Youtube links, animation, augmented reality and augmented video. Each object image is related to a set of multimedia expression data.

Each object can be related and linked to other object that has multimedia expressions. This enable to have a set of objects related that are related to one object and captured in different conditions and angles of the object and share the same multimedia expressions. For example an image in the museum can be taken images from different angles and distances and linked all the images to on image that has the multimedia expressions.

An object may be assigned to multiple titles. Each title may have properties such as location, language, target users (age) etc. The system will use the detected object and the title info to dynamically select the title provided to the user.

The present invention further provides a method for management, creation, uploading, updating and deletion of titles.

The apparatus application comprises a title selection, title search, title upload, image grabbing, sound input, speech recognition, movement detection, image, sound and movement processing, object, sound and movement detection, recognition, a tracing and multimedia output expression related to the title objects. The title may be downloaded to the apparatus from connectivity to a PC or from the network and the internet.

The apparatus of the present invention may work in network offline or online modes.

The present invention further provides systems and methods for content output, which can be automatically generated and uploaded according to age, motion, location, GPS, etc. or the content can be user-selected, such as, but not limited to, text-based, videos, augmented reality, text-to-speech, or based upon the user's personal request or interest.

One object of this invention is to provide a multimedia apparatus comprising image, sound and movement processing features and multimedia output expressions for the education and entertainment of users of all ages.

The apparatus is constructed and configured to run a multimedia image, sound and movement processing applications, which visually capture objects, sounds and movements in user surrounding; Data is processed for objects, sounds and movements detection and recognition. The apparatus outputs a multimedia expression. The multimedia expression comprises voice and/or display, The output expression corresponds to the image, voice and movement processed data, based on current and previous recorded data and expressions.

The present invention further provides systems and methods for developing a title according to a number of images of an object, wherein the content output is linked to the number of images of the same object. For example, the images can be taken at different angles/positions/magnifications/light settings of the same image.

The present invention further provides systems and methods for object detection. The system of the present invention combines local images of captured objects (identified by the system) together with web searches for the object detection. The object detection can be performed by image processing/recognition on the user's device or by sending the image information to a server in the system, and further performing image detection using the cloud. The present invention enables both local and remote object detection/recognition.

For example, the object is in an arthropod museum with many exhibitions, Each exhibition comprises is a title. When a user visits the exhibition, and the title is not in the device, the images will be sent to the cloud for searching and according to the search results the device will download the relevant title content. For example an image of a black widow spider may be downloaded.

The apparatus comprises an image sensor (Camera, CCD or CMOS image sensor, Video stream) input for image stream, a microphone input for voice stream and motion detector for motion detection. The multimedia output comprises speakers for voice and sounds output and display device. The apparatus further comprises a processing unit, capable of processing images, a storage memory (Flash) and RAM memory (SDRAM, DDR and, DDR II, for example), an interface unit, an external memory interface. The apparatus further comprises a connection to an external computer and an interface to a network and the internet.

The apparatus comprises a microphone input for a voice stream, the processing unit is capable of voice processing for detection and recognition of voice objects, letters, words, sentences, tones, pronunciations and the like.

The apparatus comprises a motion detector input for motion detection, the processing unit is capable of motion processing for detection and recognition of moving objects, tracking, human motion, gestures, and the like Motion can be detected by: sound (acoustic sensors), opacity (optical and infrared sensors and video image processing), geomagnetism (magnetic sensors, magnetometers), reflection of transmitted energy (infrared laser radar, ultrasonic sensors, and microwave radar sensors), electromagnetic induction (inductive-loop detectors), and vibration (triboelectric, seismic, and inertia-switch sensors), and the like.

The apparatus comprises a light source that illuminates the area in the field of view of the image sensor and improves scene condition in low light environment.

The apparatus comprises an External Memory Interface used for connectivity with an external memory, which may be in a form of a cassette, memory card, flash card, optical disk or any other recording means known in the art.

The external memory interface may be placed in a cartridge incorporated into the apparatus. The external memory comprises application code and data.

The apparatus comprises an interface unit comprises a plurality of function buttons, switches, touch screen for instructing the apparatus processor with user requests.

In accordance with one aspect of the invention, the apparatus may be in a form of a Personal Computer (PC), mobile phone, mobile device, tablet computer, gaming device, comprising of a camera (webcam), speakers, display device and processing unit.

In accordance with another embodiment of the present invention, the system of the present invention enables a user to add personal comments to a title or object within the title on his device, either by typing, or speaking/recording information, and then be able to flag this new material, to who it is available. In other word, the user can limit access of his personal comments to public, private, or group of authorized members. The user may use known social networks, such as Facebook and Twitter.

Furthermore, according to another aspect of the present invention, the system enables a user to use a talkback feature, which allows a user to comment on objects, and add their own media to an object, such as, but not limited to, a video, a text, audio content and the like. Thus, for each detected object, the user can view the media and the talkback, to which other users provided responses.

The apparatus may be in a form of a toy, a robot, a doll, a wristwatch, or other portable article.

The image processing elements detect, recognize and track an object (2D and 3D), and/or an object characteristic, a barcode a pattern and other visible characteristics that are integrated, attached or affixed to an object.

In yet another aspect of the invention, the apparatus may be used for education and learning of objects such as letters, words, numbers, mathematical calculation, colors, geometrical shapes, fruits, vegetables, pets, animals, and the like.

The apparatus may be used for learning of new languages, making the multimedia output expression in different languages.

In yet another aspect of the invention, the apparatus may be used for playing music, by detection of musical instruments, musical notes, Bands and Artists or other audio outputs and outputting multimedia music expression.

In yet another aspect of the invention, the apparatus may be used for commercial and advertisement by detection of commercial logos, trademarks, or commercial products, and outputting multimedia commercial output expression.

The apparatus comprises object detection, recognition and detection algorithm that is capable to detect and recognize given 2D and 3D objects in an image and video sequence. The object in the image may be detected in varying conditions and state such as different size, scale, rotation, orientation, different light conditions, colors change, partly obscured from view.

In yet another aspect of the invention, each given object has a feature data that used by the algorithm to recognize if the given object is in the image by finding feasible matches between object features data and image features data.

The object detection algorithm can be processed on the device's local processor or on the cloud.

In yet another aspect of the invention, the object feature data may be prepared in advance. This may be done for example by a service utility that receive a set of objects images and extract the object features data. The object features data may be stored in compress format, this will enable to save memory space and data transfer time to download the objects features data to the apparatus. This may improve application performance and initialization time.

Adding a new object to the application comprises adding an object features data extracted from the object image. The object features data may be prepared in external location and can be downloaded to the apparatus from the network and the internet.

The apparatus application may detect one or more objects in an image.

In yet another aspect of the invention, the apparatus comprises application programs, the application comprise a set of predefined given objects images a set of object features data and a set of multimedia video and audio expressions.

The application is using the apparatus image sensor to grab a stream of images, process the image for objects detection recognition and tracking simultaneously locally on the device and on the cloud and issues a multimedia expression that is related to the objects through the apparatuses speakers and display device.

In yet another aspect of the invention, In addition to image objects the above describes may be applied to sounds and motions.

In yet another aspect of the invention, the application comprises application content called Titles. According to one embodiment of the present invention, a Title comprises a title icon, information, a set of objects images, objects features data, Sounds, Sounds features data, movements, movement features data, augmented reality expressions and multimedia expression data. The multimedia compression data comprises video, audio, text, PDF, images, Weblinks, Youtube links, animation, augmented reality data. The video and audio data comprises a media files and/or internet URL (Uniform Resource Locator, The address of a web page on the world wide web) address.

The augmented realty expression display on the image comprise of a popup menu, buttons, markers, animation, augmented video and the like.

The title information comprises title icon, name, descriptions, categories, keywords and other information. The title multimedia expressions are related to the titles objects. Each object image, sound and movement of a title comprises object features and may at least relate to one or more multimedia expressions.

The multimedia video, audio, text, PDF, images, weblinks, Youtube links, animation, augmented reality expression may be in a form of a file or a link to an internet URL address that contains the video, audio, text, PDF, images, weblinks, Youtube links, animation, augmented reality expression (for example a link to a video file in YouTube).

The title comprises objects with a common denominator for example objects that are from movie, objects from a book, objects of a museum exhibition object of a commercial company, based on the same subject or having a common link.

The title content may be prepared in advance. The apparatus application may compute the title content and/or downloaded the title content. The download of a title may be through connectivity to a PC, to a network and to an internet web location.

The apparatus comprises external connectivity to a PC, network, wireless network, internet access and the like The apparatus application comprises features to access a data center and/or a web location for search and downloads of titles. The title search comprises a text search and/or image search, by capturing image with a title objects.

In yet another aspect of the invention, there is provided a content management system which enables to manage create, update and modify the title content. The service utility comprise the handling of the title icon, information (description, keyword, categories) objects images, object features data, Sounds, Sound features data, movements, movements features data, augmented reality display of popup menu, buttons and markers, multimedia video and/or audio expressions data (may be a file or internet web link) and the relation and connectivity of the objects to the multimedia expression. The title service utility enables to generate the objects features data.

The title service utility generates the title content used by the apparatus application.

The title service utility may run on the apparatus device, on a computer device, on an internet web base utility.

In yet another aspect of the invention, the multimedia education and entertainment apparatus may be used for games and entertainment, advertisement, commercial or medical applications.

The apparatus may have the capability to update, upgrade, and add new applications, titles and content to the apparatus. The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail then is necessary for a fundamental understanding of the invention, the description taken with the drawings making apparent to those skilled in the art how the several forms of the invention may be embodied in practice.

In the drawings:

FIG. 1A is simplified pictorial illustration of a multimedia portable communication device displaying an object-based downloaded multimedia package, in accordance with an embodiment of the present invention;

FIG. 1B is a simplified pictorial illustration showing a multimedia output displayed on the device of FIG. 1A, in accordance with an embodiment of the present invention;

FIG. 2 is a simplified pictorial illustration of a simultaneous local and distant content search application comprising items called “Titles”, in accordance with an embodiment of the present invention;

FIG. 3 is a simplified pictorial illustration of a system for simultaneous local and distant content searching and enhanced cascaded object-related content provision, in accordance with an embodiment of the present invention;

FIG. 4 is a simplified flowchart of a method for cloud title selection, in accordance with an embodiment of the present invention; and

FIG. 5 is a simplified flowchart of a method for simultaneous local and distant content searching and downloading, in accordance with an embodiment of the present invention;

FIG. 6 is a screen shot of a local multimedia communication device display with cloud titles but lacking any local titles, in accordance with an embodiment of the present invention;

FIG. 7 is a simplified flowchart of a method for downloading content to a local multimedia communication device, in accordance with an embodiment of the present invention;

FIG. 8 is a screen shot of a local multimedia communication device display with cloud and local titles, in accordance with an embodiment of the present invention;

FIG. 9 is another simplified flowchart of a method for simultaneous local and distant content searching and downloading, in accordance with an embodiment of the present invention;

FIG. 10 is a screen shot of a local multimedia communication device display of a detected object and superimposed title menu, in accordance with an embodiment of the present invention;

FIG. 11 is a simplified flowchart of a method for enhanced cascaded object-related content provision, in accordance with an embodiment of the present invention;

FIG. 12 is a simplified pictorial flowchart illustration of a game method for enhanced cascaded object-related content provision, in accordance with an embodiment of the present invention;

FIG. 13 is another simplified pictorial flowchart illustration of a game method comprising enhanced cascaded object-related content provision, in accordance with an embodiment of the present invention; and

FIG. 14 is a simplified pictorial illustration of a sequence of events in playing a game on a device using enhanced cascaded object-related content provision, in accordance with an embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

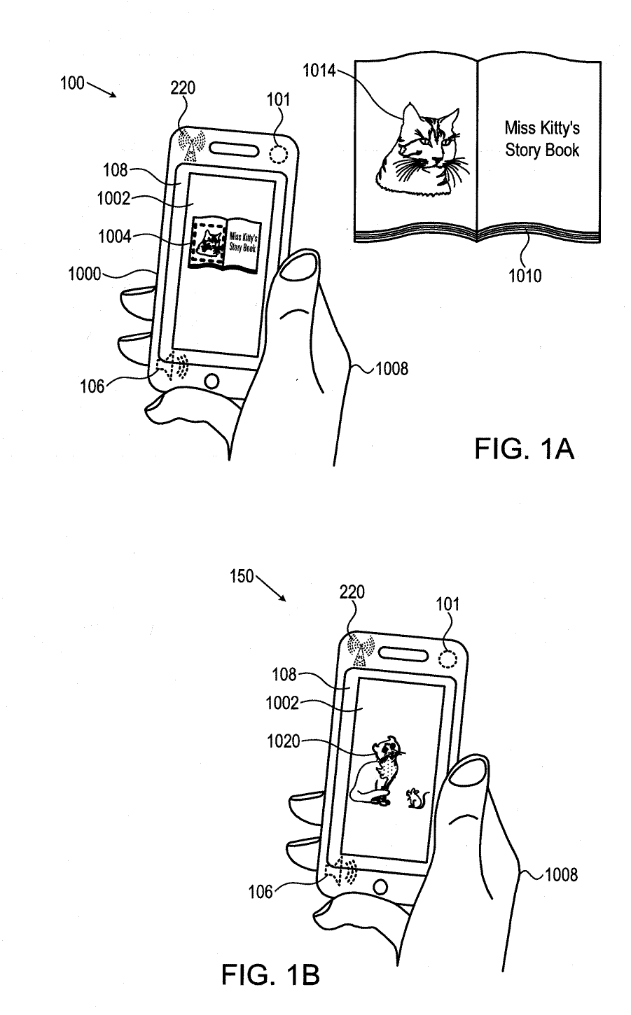

Reference is now made to FIG. 1A is simplified pictorial illustration 100 of a multimedia portable communication device 1000 displaying a content management application 1002, in accordance with an embodiment of the present invention

In FIG. 1A—a user 1008 holds a device 100. According to some embodiments, the device is a multimedia portable communication device.

Device 1000 may be any suitable device known in the art, such as, but not limited to, is selected from the group consisting of a cellular phone, a Personal Computer (PC), a mobile phone, a mobile device, a computer, a speaker set, a television and a tablet computer.

The device typically comprises a camera 101 a network device 220 speakers 106 and a display device 108. The device 1000 is constructed and configured to run a dynamic content application 1002. The user 1008 points the device 1000 camera or image sensor 100 towards any surrounding objects, such as a book 1010.

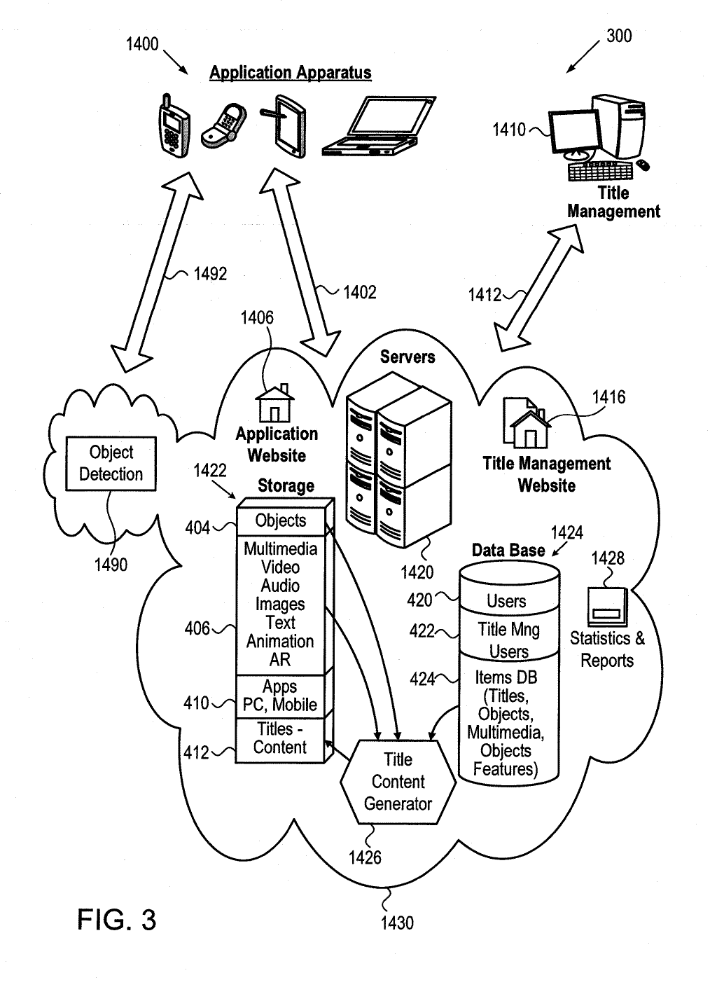

Book 1010 comprises text and object images 1014. When the device 1000 camera 101 points to the book 1010, and image 1014 is in the field of view of the device 1000 camera 101, the application 1002 in the apparatus process the images received from the camera 101 for object recognition and an object recognition algorithm in device 1000 and/or in system 300 (FIG. 3) detects and recognize the object image 1014. The device is constructed and configured to run a software package, such as a dynamic content management application 1002. Application 1002 may show the image on the device display 108 and may place a marker 1004 on the detected object, for example a rectangle 1004, surrounding the detected object image. Application 1002 processes the image for object 1004 detection and recognition. Once a decision is made on object recognition by an object recognition algorithm, the device 1000 issues a multimedia output expression 1020.

FIG. 1B shows a simplified pictorial illustration showing a multimedia output 1020 displayed on device 1000 of FIG. 1A, in accordance with an embodiment of the present invention.

One example of a multimedia output is a video expression 1020. Device 1000 comprises speakers 106 and display device 108. The application 1002 issue an output expression as an audio sound (not shown) output through the speakers 106 and/or video 1020 on the display device 108.

The multimedia output expression may be any one or more of video, clips, a textual output, animation, music, variant of sounds and combinations thereof.

The multimedia output expression may be in a form of data file located locally in the device's 1000 memory, it may be located remotely on a network in system 300 (of FIG. 3) or an internet server and stream to the device 1000 through the network device 220 connectivity.

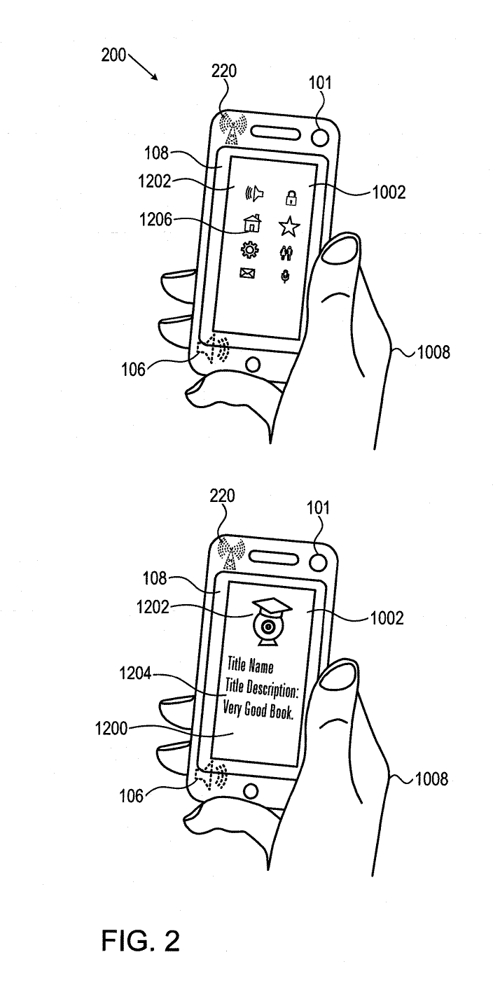

Reference is now made to FIG. 2, which is a simplified pictorial illustration of a content management application 200 comprising items called “Titles”, in accordance with an embodiment of the present invention.

A title application 1002 is constructed and configured to upload a title page 1200, comprising a title icon 1202, title information 1204, (name, description, and the like), a set of objects images, a set of multimedia video 1020 and audio expressions (not shown) that are related to the object images.

According to some embodiments, the title is typically generated on a computer 1410 in the system (300 of FIG. 3). The title may be stored in a database 1424 in the system over a period of time. Thereafter, at any suitable time, it may be uploaded onto a user device 1400, 1000. Additionally or alternatively, it may be updated or generated on a user device 1400, 1000.

The device 1000 application 1002 may display a list of titles available by the application. The list comprises a graphical icon list 1206 a text list, details list etc.

According to some embodiments of the present invention, a title comprises a title icon, information, a set of objects images, objects features data, Sounds, Sounds features data, movements, movements features data, augmented realty expressions and multimedia expression data. The multimedia compression data comprise of audio and video data. The video and audio data comprise of a media files and/or internet URL (Uniform Resource Locator, The address of a web page on the world wide web) address.

Each title comprises one or more of the following components, a title name, a title icon, a title description, a title long description, a title info, a search info, at least one title web links (homepage, youtube, twitter, wikipedia, url's), at least one title images collage, and at least one object features data.

Each object typically comprises a set of images. Each image typically contains a name, a description, an autoplay, an ordered or shuffle choice and an augmented reality expression.

Each augmented reality expression typically comprises a name, a description, an autoplay and an ordered or shuffle choice. Each augmented reality expression typically comprises at least one marker, button, augmented video and an animation.

Each augmented reality may comprise use of one or more media forms, such as, but not limited to a list of medias, which are related to one button. The media types may include any form of media, such a, but not limited to, an audio file, an offline web, an audio web-link with web online, a video file—web offline, a video web-link with web online, a Youtube link, an image web link, an image (jpeg, png), a webpage, a local webpage (on the device), a local pdf file and a local web file.

The object feature data is used by the application for a local image search. The object is detected, inter alia, by a method such as, but not limited to, a method based on natural features, that are analyzed in the target image.

Provided herewith are some typical guidelines, according to the present invention for optimizing object detection. These include, but are not limited to being rich in detail, having a good (local) contrast i.e. it has both bright and dark regions, and must be generally well lit and not dull in brightness or color and does not have repetitive patterns such as a grassy field, the façade of a modern building with identical windows, a checkerboard and other regular grids and patterns.

Each object can be related to one or more of multimedia expressions selected from the list consisting of a video file, an audio file, a text file, a pdf file, a title, one or more images, weblinks, Youtube links, an animation and an augmented reality.

The application supports various ways to display when object is detected. These include, but are not limited to, autoplay, that is when an object is detected it will automatically play the related media. The application supports a list of multimedia (video, audio, text, pdf, images, weblinks, Youtube links, animation, augmented reality) than can be played in ordered or shuffled.

Augmented reality marker is defined as follows:—when an object is detected an augmented reality marker sign or animation will appear on the detected image. Pressing the marker sign will activate the media. This function will also support a list of multimedia (video, audio, text, pdf, images, weblinks, Youtube links, animation, augmented reality) that can be played in ordered form or shuffled. The augmented reality Marker can be a 2D and 3D image.

Additionally, according to an embodiment of the present invention, the system may provide augmented reality animation. When an object is detected, a 2D/3D augmented reality animation will appear on the display. It supports a user touch to activate multimedia.

A popup menu is constructed and configured to open as a pop-up window menu with few options to choose from. Each menu item is active as a media (video, audio, text, pdf, images, weblinks, Youtube links, animation and, augmented reality).

Augmented video is defined as follows:—when an object is detected, an augmented video is overlaid above and on the detected object.

A linked object is defined as an object being linked to other object media expressions.

Selecting a title by the user from the title list may open a title page 1200. The title page comprise information on the title, comprising of title icon 1202, title information 1204 comprising of title name, description on the title, promotions, etc.

An example of a title list is a books library. The set of titles are the books, Each title represent a book, The title icon is the book cover, the title information is the description of the book and the author, The title objects are the book images located in the book cover and pages. For each image object there is one or multiple video and audio data related book images.

Another example for a title is a book about dinosaur, the title name is “Great Dinosaur”, The title icon will be the book cover, each dinosaur image will be transformed to an object feature data, and will have a related video media file with animation on the dinosaur.

Another example for a title is an animal story book, each image of the book animals will have a multimedia video expression showing the animals and its habitats. A title may be a set of objects from a variety of contents and markets. It may be related to a movie, a toy, commercial merchandise, companies logo's, and the like

The application 1002 may update and add new titles, the application may enable the user to search and download new titles to the apparatus. The title search may be based on a text data and the search will be done on the titles information and keywords.

The user 1008 may use an image base search, by taking a picture with of the object and sending the captured image to the search engine.

Once a search result is found, the user can select to download the title content to the apparatus memory. The title content comprises title icon, information, object images, object features data, audio and video files and or links and relation data between features data and the audio and video expressions. The downloaded title content comprises part of the title content and download only items that needed by the application.

The download of title content may be from a connection to a network and the internet, The titles are located in a network/internet server. the network connectivity may be a wireless connectivity or cable connectivity to a network or computing device (PC).

According to some embodiments, the title content on servers 1420 (FIG. 3) may be compressed. This will enable the saving of memory space, such as in database 1424 and reduce the time of the title download to the device 1000. In this case the downloader and/or the application are constructed and configured to decompress the compressed title content.

Applications based on cloud object detection have a large set of objects however they must be online and the detection is very slow depends on the network connection, whereas applications based on local image detection on the device have very fast object detection but are limited with respect to the quantity of objects that they can detect.

The combination of local and cloud object detection search enables to enhance the mobile device capabilities and scalability and performance.

Using titles that combines set of images, augmented reality multimedia and activity rules enables to build application based on local and cloud image detection.

The application runs on the (HW) mobile devices start to scan when it detects an image in the cloud it will detect the title the image belongs too and will bring the title information into the device, the device than will make the image detection locally using the titles image feature data. While continues to search in the cloud for new images that are not in the current title.

For example: A large museum with many exhibitions, than each exhibition can be a title. When a user enters the first exhibition, the App will detect from the cloud the one of the images of the first exhibition and will download the full exhibition into the device, now the images from the first exhibition will be detected locally and the user will be able to get the Augmented reality and media experience related to this exhibition.

When the user moves to the second exhibition than the local detection will detect the images but the cloud detection will detect the second exhibition image and will bring the second exhibition titles content to the device and now the exhibition images will be detected locally on the device.

An image can be assign to one or more titles, the network will detect all the titles that are associated with the detected image and will return a matching title according to rules and properties such as location, user profile, language.

Some museums have limitations with respect to their Network and Wifi availability. Typically, these services are not available all around the museum. Thus, using network hot-spot is a good solution to enable users to download the content for the nearby exhibition. For example, if the user is at the Wifi hotspot with his device, he can point his mobile device to an image near the network hotspot. Thereafter, cloud detection methods as described herein enable the download of the exhibit title to the device and then the user uses his device with no network (Offline) when in other places in the museum to see the downloaded titles associated with the exhibition.

The synchronized local and cloud object detection enables users to receive enhanced multimedia experiences for all their environments, including, inter alia, multimedia experiences associated with objects at home, objects in the neighborhood, objects in newspapers and magazines, which they read. Additionally, they can receive multimedia experiences associated with objects from a specific museum exhibit and/or associated with the entire museum, with all the museums in their vicinity. The systems and methods of the present invention enable provision of multimedia experiences associated with all predefined objects in a city or country. Upon each object detection, a title associated therewith is provided to the user(s).

The relative advantages/disadvantages of local and cloud searches are provided in Table 1 hereinbelow.

TABLE 1
Local and cloud search features comparison

| | Local | Cloud |
|---|---|---|
| Image size | Limited set of images. | Unlimited Images |
| | For example 100-500 | Larger than1 million |
| | images | images |
| Image detection | Image detection on | Image detection on |
| | device | cloud |
| Network | No need for network - | Network connection, |
| | Work offline. | Online work. |
| Detection time | 0.1 sec (2-3 camera | Response time up to 3 |
| | frame) | seconds |
| Object feature data | Requires multiple | One object feature data |
| Database (For example | object datasets of | database |
| Museum with 1000 | object feature data. | (For Museum all |
| images) | (For museum 10 | images features data in |
| | object feature data | one dataset) |
| | dataset of 100 images | |
| | each) | |

Reference is now made to FIG. 3, which is a simplified pictorial illustration of system 300 for simultaneous local and distant content searching, in accordance with an embodiment of the present invention.

It should be understood that system 300 may include a global positioning system (GPS) 302 (not shown) and devices 1000, 1400 may be trackable using the GPS system 302, as is known in the art.

The environment of the apparatus comprises apparatus devices 1400, 1000, FIG. 1), network connectivity 1402, a title management system 1410, title management network connectivity 1412, and optionally a geographic positioning system (GPS) system 302. System 300 further comprises a communication network and/or an internet 1430, an application website 1406, a title management website 1416, servers 1420, storage 1422, database 1424, title content generator 1426 and statistics and reports 1428. The system further comprises an object detection device 1490.

The apparatus device 1400 and the title management 1410 may run on the same apparatus device, with the same website 1406, 1416 the same network connectivity 1402, 1412 and 1492 and by the same user. It is separated in this drawing for the clarity of the description.

The Network 1430 may be a computer network, Local Area Network (LAN), Wide area network (WAN), Virtual Private Network (VPN), company network, The Internet network and the like, as is known and practiced in the art. The network may be allocated at the Cloud computing network. (Cloud computing provides computation, software, data access, and storage services that do not require end-user knowledge of the physical location and configuration of the system that delivers the services).

The connection of the apparatus to the network 1402, 1412, 1492 is through the apparatus network interface, it may be a physical network cable, preferred USB or standard network cable, it may be a wireless connectivity, preferred Wi-Fi, Cellular connectivity, Bluetooth, and the like, as is known and practiced in the art.

The Servers 1420 are in communication with at least one physical computer 1410, located in the network 1430 and used for computing and management of the websites 1406, 1416, applications and titles downloads, titles management and creation 1426, object detection 1490, object detection network connectivity 1492, storage 1422 management, database management 1424, object detection 1490 and management of the statistical and reports 1428.

The storage facility or memory 1422 is located on network 1430 and contains the applications and title content, title objects images, the multimedia Video, Audio, Text, PDF, images, Animation, Augmented reality data, and management data.

As was elaborated hereinabove, title data stored in storage memory 1422, may include objects 404, multimedia content 406, applications 410 for mobile and/or PCs and titles content 412 and combinations thereof.

Database 1424, located in network 1430, contains the information of users 1008. The information may include one or more of data associated with the users 420, users' title management data 422 and items database 424. The items database comprises user-associated titles including images, video, audio, object features and the like and combinations thereof.

Management of the titles content comprises determining the relation of the title components comprising of title information, objects images, multimedia expression Video, Audio, Text, PDF, images, Weblinks, Youtube links, Animation, Augmented reality.

The Title-Content generator 1426 is a service utility that receives the title object images and multimedia expression data and is constructed and configured to create object features data, which is required by the image processing algorithm to detect and recognize the titles' objects.

The statistical and reports 1428 and log of users, titles popularity, and the like, is saved in database 1424 and/or in storage memory 1422.

The user may manage titles, upload titles content comprising of title information, images, multimedia Video, Audio, Text, PDF, images, Weblinks, Youtube links, Animation, Augmented reality data, create titles object features and prepare titles for application downloads.

A user downloads the application and titles content to the apparatus device 1400. The download may be from the network and/or internet website 1406 or from online software store for application for example Apple App-Store, Android Market.

The object detection 1490, receives from the devices 1000, 1400, a captured image or image feature data information through the object detection network connectivity 1492 and processes object detection algorithm for matching objects of objects stored in the network (cloud) 1430 object feature data in the database 1424 and storage 1422. When an object is detected, the detected results will return to the requesting device 1000 1400 through the object detection network connectivity 1492. The results returned to the devices 1000 1400 comprise the detected objects and metadata on the objects, titles and media. The object detection 1490 and object detection network connectivity 1492 may be located on another network (Cloud) separate from the title management network (1430). When the user manages titles and objects on network 1430, the server 1420 uploads each object to the separate detection network.

For example, if the object is in an art museum with many exhibitions. Each exhibition is ascribed a title. Each title comprises the exhibition paintings and related media. When a user visits the exhibition, and the title is not in the device, the images will be sent to the cloud for searching and according to the search results the device will download the relevant title content for the detected painting and for the whole exhibition.

The server 1420 receives from the object detection 1490 or from the device 1000, 1400, the detected object info and sends to device 1000, 1400, the matching title. The matching title contains the object info and media content. The server 1420 allocates all the titles that are related to the detected object and returns the appropriate title content that match to the device location and user profile.

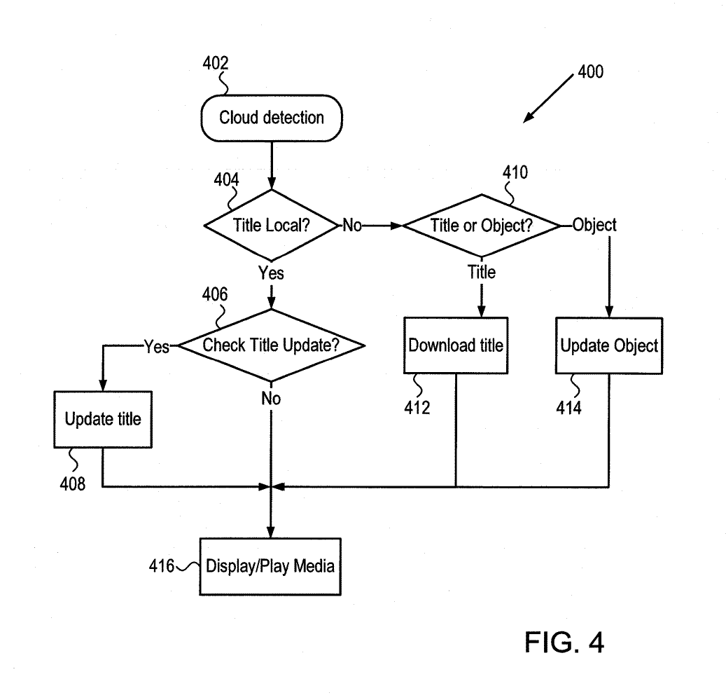

Reference is now made to FIG. 4, which is a simplified flowchart of a method 400 for cloud title selection, in accordance with an embodiment of the present invention.

A cloud search feature requirement includes, for example one or more of a trackable/object in the cloud meta data information typically including a title name, a title ID number, an object name, an object ID, a title version number, an operation mode: title download/update, object download/update, play immediately, media information including the items links that support the media (markers, buttons, resources).

The apparatus (device) 1404 sends captures images to the Network object detection (1490), thru the network connectivity 1492 to search for a matching object.

On a cloud detection 402 of an object, the apparatus (device) 1400 will receive the object detection information including the object metadata comprising the object identification data, the title associated therewith data related to the object, the title version, operation mode and other relevant data.

In a local title detection step 404, the application checks to see if a specific object detected by apparatus (device) 1400 is already has a title package downloaded and installed down to the device. If yes then in a checking update version step 406, the application will then check if the local title is updated. (Compare the object version to the downloaded title version, or check with the cloud network the latest title version).

If title is updated, then in a displaying step 416, the media is displayed (for example, the media comprises autoplay, popup menu, marker and augmented reality video.

If title is not updated, then in an updating title step 408, the object title is updated to the latest version. This may be performed by first downloading all of the items related to the detected object and, thereafter, starting the activation while downloading the rest of the title in the background. Thereafter, the displaying/playing step 416 is performed as described hereinabove.

According to some embodiments of the present invention, the checking title update step 406, can be done only once in a session.

According to some embodiments of the present invention, if another image is cloud detected in the current session, then there is no need to recheck again that the title is updated.

Turning back to step 404, if no local title is found, then a title or object standalone check is performed in a checking step 410.

When an object is detected in the cloud in step 410, if it is not in a local title then:

If the operation mode is “Title Download”—then download the title in a title downloading step 412 and then Display/Play the media in displaying/playing step 416.

The network 1430 returns the title that contains the detected object. If the object is in multiple titles, the network will return the matching titles.

If the operation mode is “Object Download/Update”—then download/update the object information in an updating step 414 and then Display/Play the media in displaying/playing step 416. In this mode, only the object media content will be used as stand alone, not related to a title.

The object metadata will include all the information and links that needs to be used by the object media (Markers, buttons, resources object feature data and media).

Titles may have or may not have local objects features data files. It is not a must for a title to have an object's feature data. The titles may be of the following format regarding the objects features data
Objects are in the cloud and local objects features data files: all the objects of the title can be detected locally on the device or in the cloud.
Objects only in the cloud (No local objects features data files): The detection will be in the cloud, however the title media will be locally (A title without object feature data.)
Objects in the cloud and part are in the local objects features data files (for example a newspaper with 500 images, only 100 images will be in the local object feature data and the rest will be detected in the cloud, All the media rules will be locally).

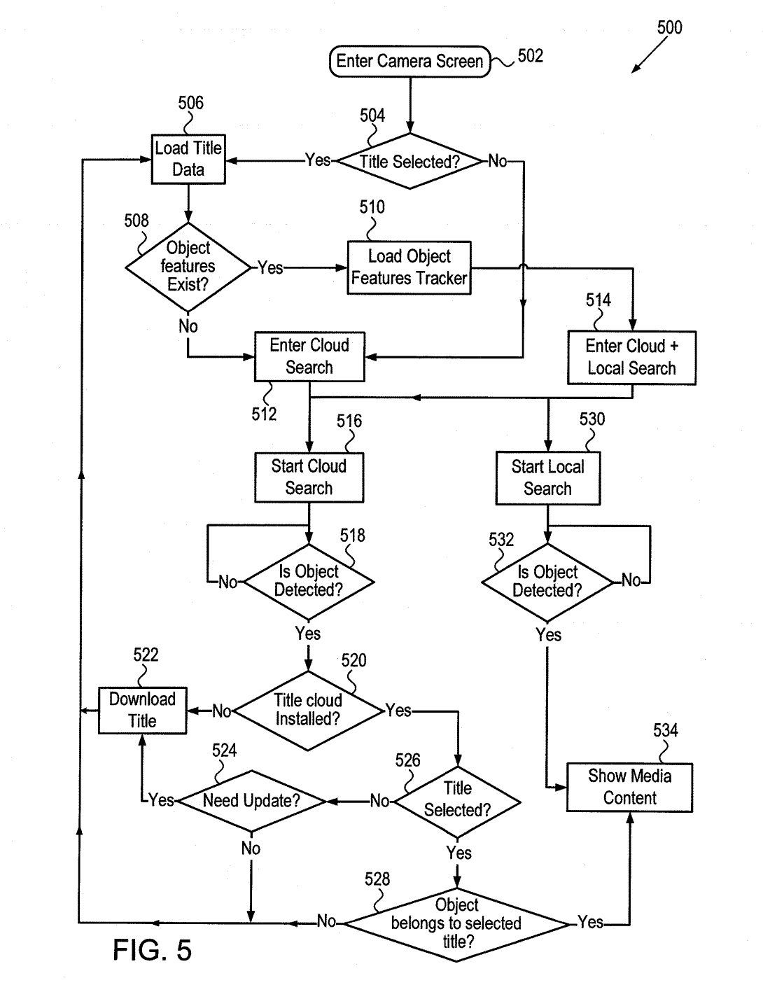

Reference is now made to FIG. 5, which is a simplified flowchart 500 of a method for simultaneous local and distant content searching and downloading, in accordance with an embodiment of the present invention.

The apparatus 1400 (FIG. 3), for example, of the present invention supports simultaneous local and cloud searching, as is exemplified in FIG. 5.

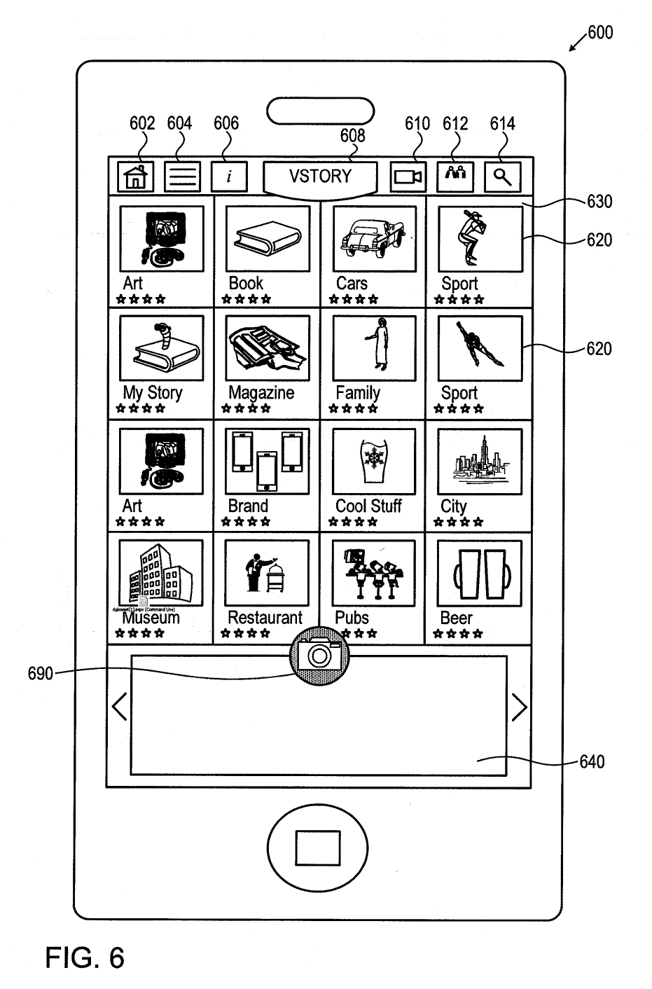

In an entering a camera screen step 502, a user activates the camera screen of the device (see screen shot in FIG. 6). In this step the user may search for a specific title. The device screenshot 600 comprises at least one toolbar with a number of screen buttons 602, 604, 606 and 610. The buttons may represent, for example a home button 602, a categories menu 604, an “about” icon 606 and a video demonstration button 610. There may also be a company logo 608.

Additionally, the screen shot comprises an array 630 of cloud title icons 620 and a lower display region 640 of local titles. At first, there may be no local title icons.

In a checking title selection step 504, the application checks to see if a title has been selected. If yes, the title data is loaded in a loading title step 506.

In a checking if objects feature data exist for that title step 508, the system checks if there are pre-existing objects features data. If yes, then a loading Objects features tracker step 510 is performed. If no, then an enter cloud search step 512 is performed. It should be noted that this step can be performed in parallel with a simultaneous cloud and local searching step 514.

Thereafter, a start cloud search step 516 is performed in parallel to a start local search step 530.

Thereafter, a local checking for object detection step 532 is performed simultaneously with a cloud checking for object detection step 518. If no objects are detected then the search(es) is(/are) continued.

If the object is detected either/or locally and in the cloud, then either the media content is displayed in a displaying step 534 (when found locally) or the title is installed locally (per FIG. 4 hereinabove).

Thus, when selecting a title (or scan), the title is loaded with its object feature data (if it exists), in a downloading title step 522. When an object is detected locally, the application displays the local media.

When an object is detected in the cloud, it will return the metadata including title name, object name and the media list.

When getting the info and metadata from the cloud should give an option to download the full title.

When getting media info and metadata from the cloud should add permission to download info and then may be operative to add a payments charge.

When a media is played from the cloud and has a media list, need to keep history and index of played data, so next time will play the next media. Also keep track of a Video/Audio where it was last stopped.

When detecting an object from the cloud and title already exist locally then check for requirements to update in an updating title step 524 and load the objects feature data(if exist) and continue both with cloud and local search making the title of the detected object to be the current title loaded. Once all the updated data has been loaded locally, a check to ensure that the object belongs to the selected title step 528 is performed. If affirmative, then media content is displayed in step 534.

The replace of the local objects feature data can be at runtime. If the local objects feature data set is not loaded in the memory, then the objects feature data replacement can be done in the background when the Object media is played—the camera will be off and the load of the objects features data will be loaded.

Marker/Buttons—when an object is detected in the cloud and has a marker/buttons that is not located locally in the App, then it will be downloaded from the cloud site and upload dynamically by the graphic engine. Otherwise a default marker will be used. The metadata of the object in the cloud can include the marker file/link.

When an object is detected, the app will display a popup menu/Marker/augmented video or a media. When this kind of activity is done then the cloud search may be disabled during this time. When no object detected and augmented display (Marker/Menu) or media finished to play then the cloud search will be enabled. When this kind of activity is perfume we disable the cloud search when an object is detected locally—This will save performance and network activity and display activity—Will also save battery performance.

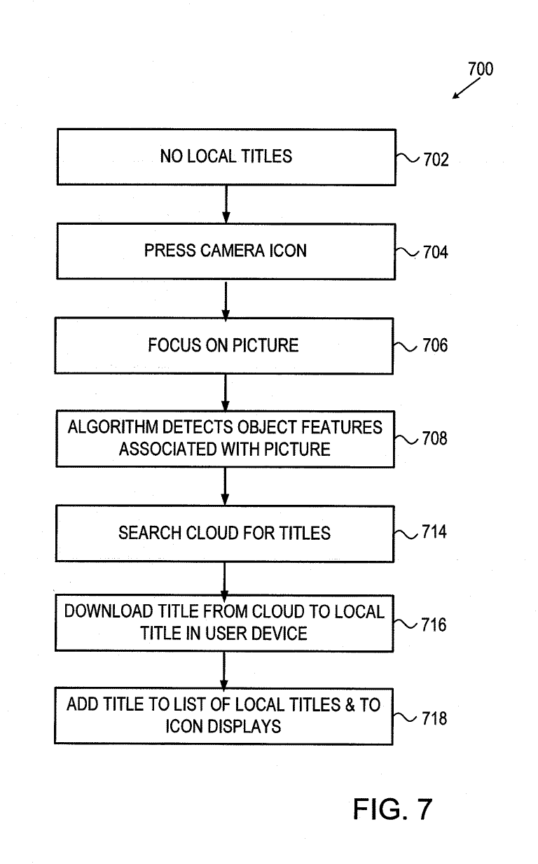

FIG. 7 is a simplified flowchart 700 of one embodiment of a method for downloading content to a local multimedia communication device, in accordance with an embodiment of the present invention.

If no local titles are found in a checking local titles step 702, then the user presses on his camera icon on his device in an activating camera icon step 704. He/she then focuses on a picture/image of interest in a focusing step 706.

In an object features detection step 708, an algorithm detects the object features associated with the picture/image of interest.

A cloud search is performed in a cloud searching step for title 714.

Once found, the title is downloaded in a downloading step 716 from directly from the cloud or from the array 630 of cloud title icons 620 on the device and is transferred to the lower display region 640 of local titles in a local title addition step 718.

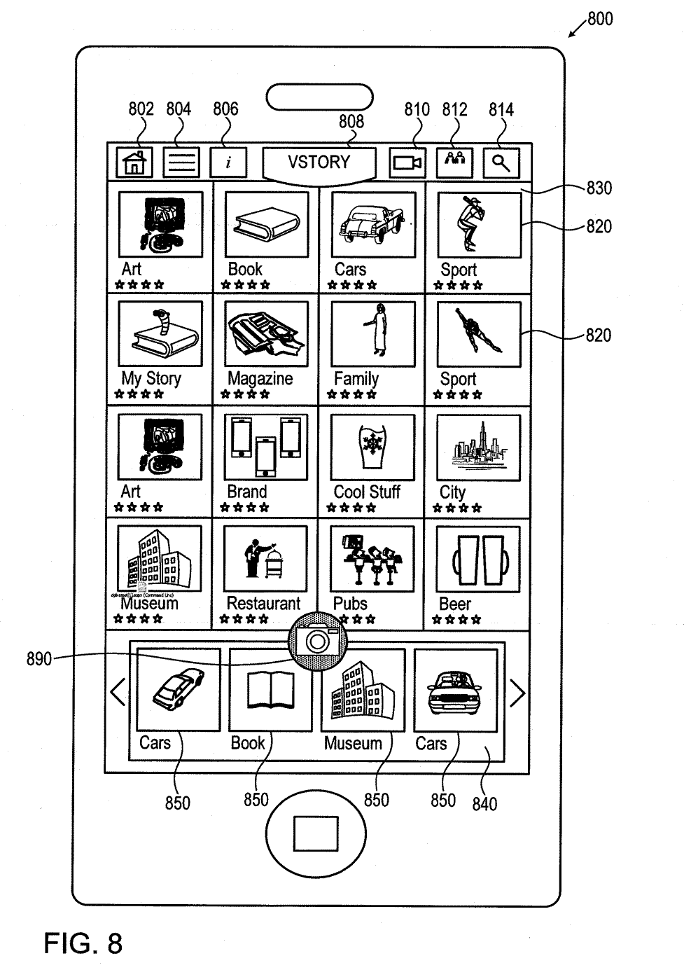

FIG. 8 shows is a screen shot 800 of a local multimedia communication device display with cloud titles 820 and local titles 850 in local display region 840, in accordance with an embodiment of the present invention. FIG. 8 further shows further buttons in the toolbar 801. These are for example a social button 812 and a search icon 814.

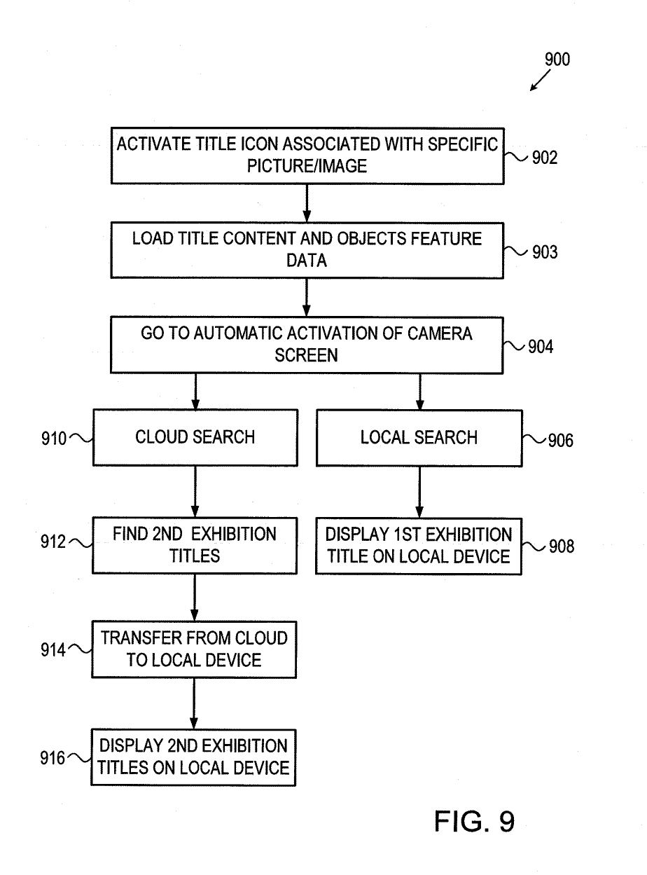

Reference is now made to FIG. 9, which is another simplified flowchart 900 of a method for simultaneous local and distant content searching and downloading, in accordance with an embodiment of the present invention.

A user sees screenshot 800 (FIG. 8) on his/her device. The user activates a title icon associated with a specific picture/image, such as a museum icon 850 associated with a museum, in an activating title step 902. This title represents, for example, the first exhibition of this museum.

Thereafter, in a loading step 903, the selected title content and the title objects feature data for local object search is loaded to the device in step 903.

Thereafter, he activates the camera in an automatic activating of the camera screen step 904.

The device application algorithm, as described herein, activates both a cloud search in a cloud searching step 910 and a local search, in a local searching step 906.

The local search display the media expression for the object detected of the titles associated with a first exhibition, which the user is attending, in step 908.

In parallel, when the user moves to the second exhibition, for which the exhibition title is not local on the user device, the cloud search provides results of further up and coming exhibition titles in the cloud in a further cloud search, associated with the location step 912.

The algorithm is constructed and configured to transfer the data from the search to the local user device 1400 (FIG. 3). In a displaying step 916, the device displays the additional data.

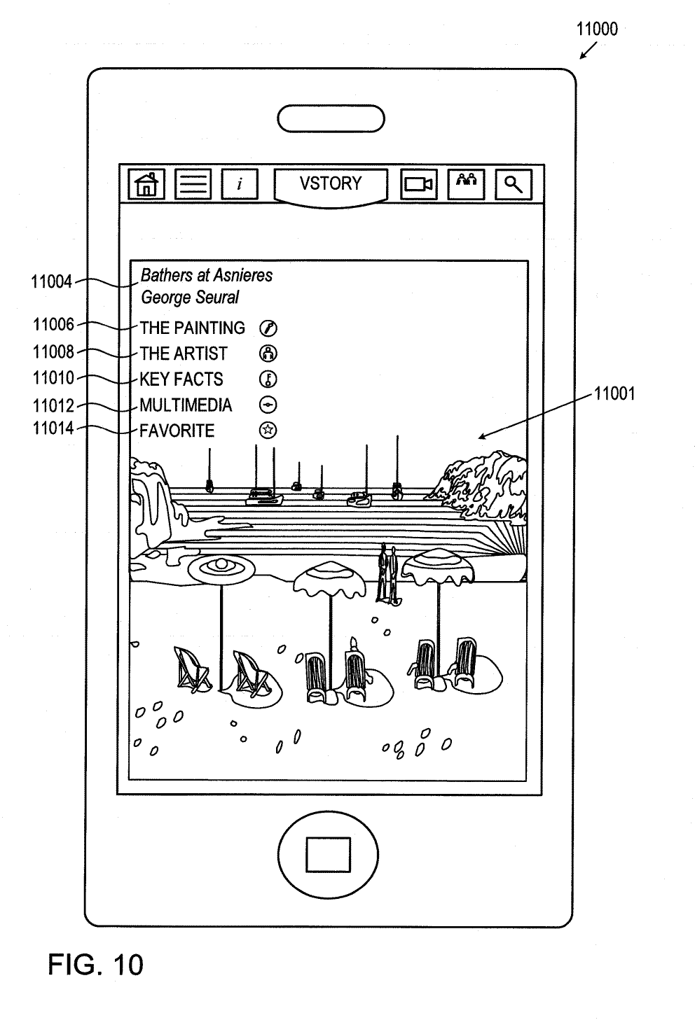

FIG. 10 shows a screen shot 11000 of a local multimedia communication device display of a detected object 1002 and superimposed title menu 11004, in accordance with an embodiment of the present invention.

The title menu comprises a dropdown menu of on-screen icons associated with the image. These icons may include information about the detected object 11006, information about the artist/inventor/author of the object 11008, key facts about the object 11010, multimedia associated with the object 11012 and an icon to add to ones favorites 11014.

Another example of a concurrent local and cloud search is described hereinbelow. First a user enters the camera screen. He may enter the camera screen while pressing on specific title or by pressing camera button, on the bottom line user can enter with or without a title. If the user entered with the title, then the previously downloaded title contains objects feature data files. The contain objects feature data files will be loaded, recognition will be based on local objects feature data files and the cloud. Upon local recognition, media content is shown.

Upon cloud recognition, the object, which belongs to current loaded title will show media content. If the object does not belong to currently loaded title, the flow proceeds to B (the case of a user without a title). If the previously downloaded title contains no objects feature data files, no objects features data files will be loaded, and object recognition will based only on the cloud. Once there is cloud recognition, the flow proceeds to C.

If the user entered without title, then only cloud recognition is active. Upon object cloud detection, the system checks if title of the object was already installed. If the title was previously installed then it checks for update on the first time-uploaded data and then it swap to a current title and makes flow like a (user with title).

If the title not installed, then the system is operative to download the title from the web, swap to current title, makes flow like a (user with title) and to perform cloud enhancement.

Detection of multiple objects in one image, for example, if we have five paintings in the detection, then the cloud results will include all the list of detected images.

One object can be loaded to the cloud multiple times. The cloud is constructed and configured to return a list of matching data. Additionally or alternatively, the cloud returns the correct title. However, this feature is dependent on the location, country and user profile. For example multiple images of a famous painting (Mona Lisa) in the cloud will return the title according the user location (Louvre or at home).

Some embodiments of the invention are herein described, by way of example only. For purpose of explanation examples are set forth based in image processing in order to provide better description of the invention. However, it will also be apparent to one skilled in the art that the invention is not limited to the examples described herein and applied to sound and motion.

In one general aspect of the invention, a multimedia image processing apparatus comprises a camera image sensor for image stream input, a microphone for voice stream input, a motion detector for motion detection input, a Processing and control platform capable of image signal processing of the images captured by the image sensor. The processing and control platform processes the input images stream for objects detection, recognition and tracking from the images.

The processed data is stored in memory with the history of previous detected data.

The processing and control platform processes and calculates the output expression based on the new image processed data and comprises the previous history data user profile and user location to determine the multimedia output expression. The multimedia expression may be output through the apparatus speakers and display device.

In yet another aspect of the invention, the image object detection recognition and tracking comprises faces detection and recognition, emotions, face tracking, letters, words, numbers, math calculation, geometrical shapes, colors, fruits, vegetable, pets and any other objects captures by the image sensor.

In yet another aspect of the invention, the application running on the apparatus comprises titles. Each title comprises object features data that are used by the image processing algorithm to recognize the object. Each object has a related set of multimedia video and/or audio expression that are played by the apparatus when the related object is detected. The multimedia expression may be in a form of a multimedia file or an internet web URL link.

In yet another aspect of the invention, the apparatus application may, compute the object images and extract the object features data at the initialization stage of the application.

In yet another aspect of the invention, the title content comprising the object detected features and the multimedia expression are prepared and created in advance. A service utility may be used for title content preparation and generation. The title content may be downloaded to the apparatus storage memory. The application running on the apparatus will load the prepared title content comprising the object features data to the apparatus RAM memory.

This method of loading the prepared title content from the storage memory may improve the application performance comprising of improving the initialization time.

In yet another aspect of the invention, the apparatus may also be interactive with the learner comprising learning activities, questions answering, riddles solving, Challenging, Finding, Counting, Story-telling, games and entertainment.

The apparatus may be in a form of a stand-alone embedded electronic platform wrapped by a user friendly cover, preferred a toy, a robot, a doll and the like.

The apparatus may be in other form as a Personal Computer (PC), desktop, laptop, Notebook, Net book, mobile device, mobile phone, smart phone, PDA, tablet, electronic gaming device, wristwatch, MP3 player, MP4 player and the like

In yet another aspect of the invention, the method and apparatus, enables transforming any object into an interactive experience using object recognition technology. A method and a service utility that match interactive multimedia expression content (i.e. song, sounds, short animations, films, jokes and the like) to an object image. The service utility will allow companies and individuals to upload photos and matching content and transform it into an interactive application.

Then, once a person using the apparatus application points any camera be it smart phone or a webcam to that object, the application will recognize the image and play the matching interactive content.

The method and apparatus bring objects and images to an interactive multimedia experience—be it pages in a book, family pictures, bedding, street signs, stickers, dolls, games objects (i.e. cars, Lego) or any other form of objects and images.

The apparatus application enables the user to combine ‘old fashioned’, ‘pre digital’ toys and books, signs, printed catalogs and the like, with new and interactive experience, it will be attractive for user who wish to get an experience of connecting between real objects to interactive, educational, fun, commercial, medical or other content.

The user of the apparatus application comprises the following application operation, At first the user select a title of his interest. This may be a book the user have, a toy, a doll, a picture, or images on a wall. Once the title is selected, the user points the apparatus device image sensor camera to the objects in his surrounding that are related to the title. Once an object is detected by the apparatus, the apparatus will issue a multimedia expression.

As an example, The user may be a child with a set of dinosaurs toys, The user select the dinosaur title in the apparatus device application and points the apparatus camera to the dinosaur toys, Once the dinosaurs toy is detected by the apparatus an audio sound is played with the dinosaur voice and a video is played in the apparatus display device showing a movie about that dinosaur. In another example, the child may paint on a coloring book, once the child points the apparatus camera to the painted image in the book, the apparatus detects the painted image and issue a related animation video.

In yet another aspect of the invention, the method and apparatus for multimedia image processing application is to enable the book publishers a service utility that brings books to life so that they can further enhance the experience for their readers by making traditional books more interactive, educational and fun. The service utility will enable publishers to easily upload objects images and associated multimedia expression content. For example a child pointing the apparatus camera (for example mobile device, gaming device, smart phone, iPhone, Android) to a story in a book and hearing the story read by the author, or appointing to a photo of a dinosaur to enjoy the sound of that dinosaur in its natural environment with a short explanation or a related animation displayed on the apparatus display device. Once the book title content is downloaded to the apparatus application the reader can point the image sensor to the images of the book and receive a multimedia expression.

The interactive book will contain, for example, a description and an internet web link with the details on the application and book title and installation instruction. The description may be printed in the book or as a label sticker that is attached to the book.

In yet another aspect of the invention, the method and apparatus for multimedia image processing application is to enable the toys companies a service utility that brings toys to life so that they can further enhance the experience for their players by making toys more interactive, educational and fun. The service utility will enable toys companies to easily upload toys objects images and associated multimedia expression content. For example a child playing with famous movie toy, pointing the apparatus camera, to the toy and seeing an animation movie clip of the toy in the apparatus device display. Once the toy title content is downloaded to the apparatus application the player using the apparatus application can point the image sensor to the toy and receive a multimedia expression.

In yet another aspect of the invention, the method and apparatus for multimedia image processing application is to enable the music companies a service that brings music to life so that they can further enhance the experience for their users by making music instruments, CD's and the like more interactive, educational and fun. The service will enable music companies to easily upload musical objects images of for example musical instruments, musical notes, bands and artists, musical logo's, musical names or other audio associated therewith or associated multimedia expression content.

For example a user points the apparatus camera 101 (FIG. 1A), to a musical instrument and listening to the instrument sound from the apparatus speaker, a user pointing the apparatus camera to a famous artist image and seeing a musical clip of the artist in the apparatus display. Once the musical title content is downloaded to the apparatus application the user can point the image sensor to the musical objects and receive a multimedia expression.

In yet another aspect of the invention, the method and apparatus for multimedia image processing application is to enable the advertising and business companies a service that enhanced their product experience and usage to the user customer, making the product more informative, interactive, educational and fun. The service utility will enable advertising and business companies to easily upload objects images and associated multimedia expression content. For example a user pointing the apparatus camera to a company product or a logo and receive a multimedia expression on the apparatus output. Once the product title content is downloaded to the apparatus application the user can point the apparatus image sensor to the product and receive a multimedia expression.

In yet another aspect of the invention, the method and apparatus for multimedia image processing application is used for educational purposes, to enable education content a service utility that brings educational material to life so that they can further enhance the experience for the learner by making traditional educational material more interactive, educational and fun. The service utility will enable educational content supplier to easily upload educational objects images and associated multimedia expression content. For example a student pointing the apparatus camera to a study book images and getting enhanced educational information on the pointed object. Once the educational title content is downloaded to the apparatus application the learner can point the image sensor to the images of the educational material and receive a multimedia expression.

In yet another aspect of the invention, the method and apparatus for multimedia image processing application may enable users to use the service in a personalized way. For example a grandfather picture can transform into a newly uploaded personal greeting when a kid points a camera to it.

The method and apparatus for multimedia image processing can be applied to any sector, market and industries. The apparatus and application can be used for multiple markets.

According to further embodiments of the present invention, a mobile device, such as apparatus 1400 (FIG. 3) is constructed and configured to run simultaneous local and cloud content searching, such as exemplified in herein (for example in the method of FIG. 5) may add another simultaneous search, based on a geographical location of the mobile device.

According to additional embodiments of the present invention, a content-associated package (named title herein) is constructed and configured to comprise objects, object's feature data, media, which may comprise geographical location coordinates of the device and/or of a subject/object in the title. The geographic location coordinates may include location of a center of the device/subject/object and a radius extending therefrom.

The device relays its geographical location information to a network (see FIG. 3). The network processing returns the title or titles, whose location is in the vicinity of the device location. This function enables the device user to download titles associated with his current location or in the vicinity thereof. For example, a device user, who in a museum, receives a list of exhibits titles that are in the museum, based on his geographical location in/near the museum and the titles which are associated with the museum location area. The user can then select to download the titles-exhibits that he is interested to visit.

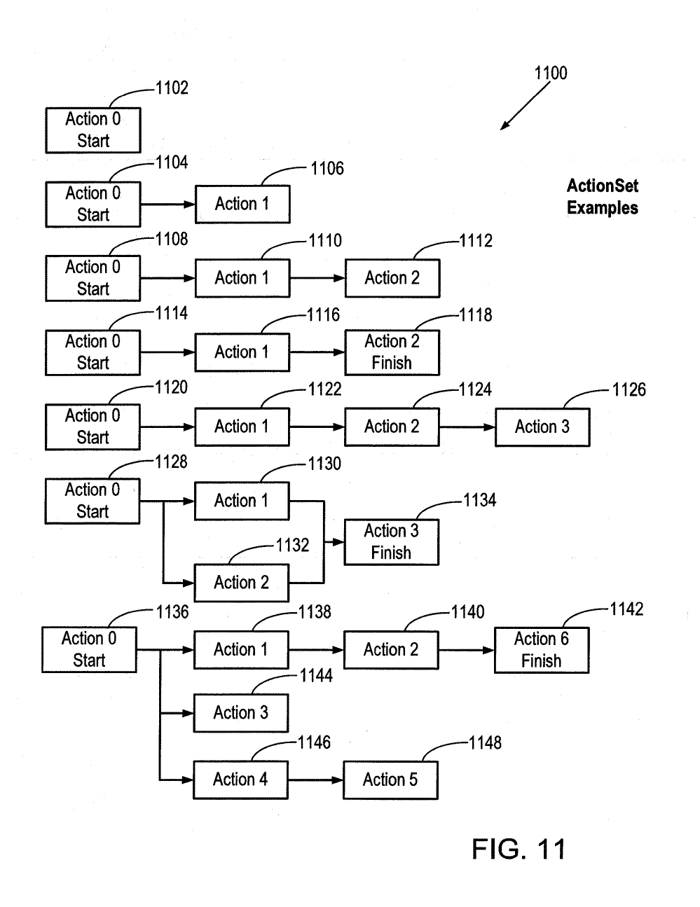

Reference is now made to FIG. 11, which is a simplified flowchart 1100 of a method for enhanced cascaded object-related content provision, in accordance with an embodiment of the present invention.

FIG. 11 provides several non-limiting examples of single and multiple step cascades for enhanced cascaded object-related content provision. For example, a user activates his/her mobile device and it performs a scan and detects an object. This activates a “start” action of the device in a start step 1102 which may display an augmented animation.

In a start step 1104, similar or identical to step 1102, the device may wait for a predefined time delay and thereafter the device or the user may perform a first action in action step 1106.

Image recognition and augmented reality application, provided in/to the device enable to connect between objects and media. The connection can be using an augmented expression on the detected object such as marker, buttons, popup menu, animation, 3D markers, augmented video and the like.

Each one of the augmented expressions may link to a multimedia expression such as video, audio, web links, PDF and the like. Title enhancement adds additional capabilities, features and logic to the title and to the media. The title enhancement enables to decide the action and media that will take place when the object is detected, when the object media is played and after the object media is played. Title enhancement enables to add the location information of the title and object with the activity and actions. Title enhancement further enables to create games, treasure hunt, vision clues, user experience, post-visit activities and other enhancements.

The actions may have few types of behaviors and activities, such as, but not limited to:—

a) Start: This is where the start point of the action is. The action flow starts from this action. It may have an active operation or may have a link to a list of one action, a list of actions or a list of serial cascade actions.

b) Finish: This is the end of the action. The finish indicates that the next time the object is detected, the activity will be from the start action, another usage for example in treasure hunt to define the completion of the current stage.

c) Display operation: This displays an augmented expression on the device display (marker, menu, animation and the like).

d) Media operation: This displays at least one medium, such as video, audio, a slideshow or the like.

e) User input: The user may input a text, a recording, an audio file, an image from a camera or the like.

One non-limiting example of a serial cascade is shown in steps 1108, 1110, and 1112. For example, an object is detected and trigger a calls to start step 1108, then action 1 1110 is performed, such as displaying a 3D Button, when the user press the button, action 2 1112 will display a video to the user. One non-limiting example of a serial cascade is shown in steps 1114, 1116, and 1118. For example, an object is detected and trigger a call to start step 1114, then action 1 is performed, such as providing an audio-visual video to the user. In step 1116, the user inputs data to the device in response to the audio-visual video, such as answering questions uploaded in response to the video in step 1118. Action 2 activity composes a finish stage that indicates that the action set is completed on the related detected object.

A second non-limiting example of a serial cascade is shown in steps 1120, 1122, 1124 and 1126. For example, an object is detected and trigger a call to start step 1120, then action 1 is performed, such as providing an audio-visual video to the user. In step 1122, a second audio recording is activated, after the video of step 1122 is completed. For example the audio recording in step 1124 may be verbal questions in response to the video. Then, in step 1126, the user inputs data to the device in response to the questions in response to the audio questions of step 1124.

One non-limiting example of a series and parallel cascade is shown in steps 1128, 1130, 1132 and 1134. For example, an object is detected and triggers a call to start step 1128 and then actions 1 and 2 are performed in parallel in respective steps 1130 1132. For example, these steps could be showing a slide show on the device and providing an audio recording in the language of the user, respectively. When both these steps are completed, a third action, such as a user input into the device is performed in step 1134 and then the cascade is completed.

Another non-limiting example of a series and parallel cascade is shown in steps 1136, 1138, 1144, 1146, 1140, 1148 and 1142. For example, an object is detected and triggers a call to start step 1136 and then actions 1, 3 and 4 are performed in parallel in respective steps 1138, 1144 and 1146 respectively. For example, these steps could be showing a slide show on the device and providing an audio recording in the language of the user and providing an alarm, respectively. When action 4 is completed, action 5 is activated, such as audio music to the user in step 1148. In parallel when action 1 is completed with a question, Then the user can email a response, for example in action 2 (step 1140) and then he presses an onscreen finish button in action 6, step 1142. That has a Finish stage which will indicate that the activity for the current object is completed. The finish indication in this case, for example may indicate in a checkbox game that the box that represents this detected object is marked.

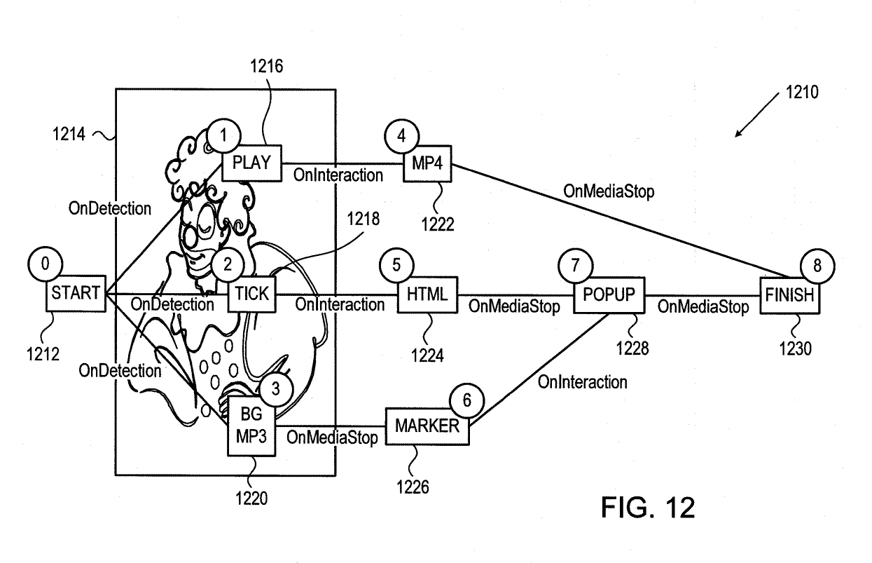

FIG. 12 is a simplified pictorial flowchart illustration of a game method 1210 for enhanced cascaded object-related content provision, in accordance with an embodiment of the present invention.

The user activates the device to scan an object. The object is detected in step 1214 and then triggers a call to start step 1212 which activate three actions 1216 1218 and 1220. In step 1216, a 3D marker in a form of “Play” button is displayed. In step 1218, an onscreen marker in a form of a tick sign is displayed. On detection of the object, audio is played in step 1220. Each of these three steps activates a further action upon user interaction, namely step 1222, 1224 And 1226, in which video in a format of MP4 media 1222 is played after user presses the play button in stage 1216, HTML web link 1224 is open after the user press the tick sign 1218 and a marker 1226 is provided to the user via the device display after the audio play 1220 is completed, respectively. When the media of step 1224 is completed, a popup is activated in step 1228. Additionally or alternatively, this may be activated by user interaction with the marker in step 1226. A finish step 1230 may be activated by completion of steps 1222 or 1228.

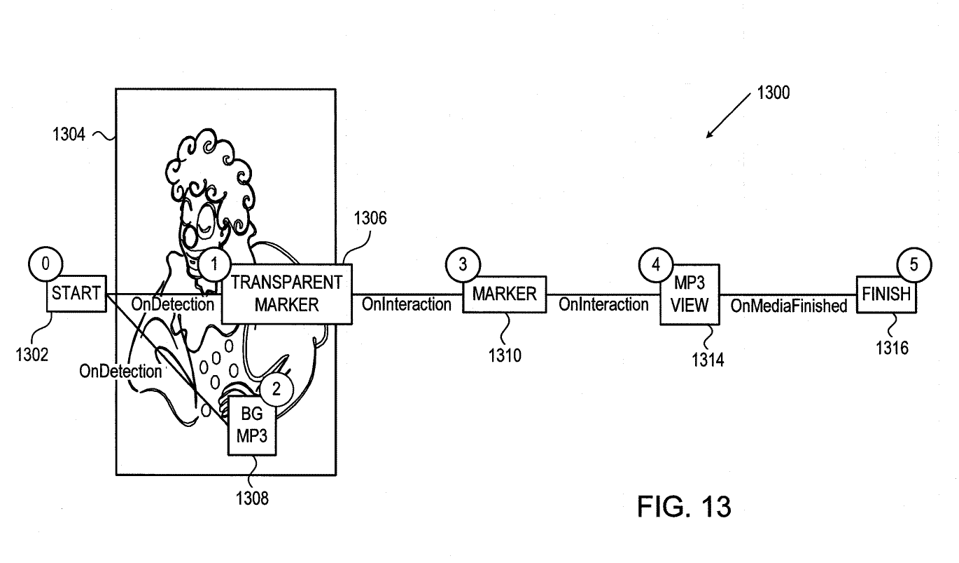

FIG. 13 is another simplified pictorial flowchart illustration of a game method 1300 comprising enhanced cascaded object-related content provision, in accordance with an embodiment of the present invention.

The user activates the device to scan an object. The object is detected in step 1304 and then triggers a call to start step 1302, which activate two actions 1306 and 1308. In step 1306, a transparent marker is uploaded above the detected object. In step 1308, audio in MP3 format is played in the background, which relate to the detected object. On interaction of the user with the marker, step 1310 is performed, in which the marker may be fixed on a certain part of the object, such as a horse's head. The user interacts and touches the transparent marker and then in step 1314, the device upload further media, such as Audio in MP3 format and View with text information on the object. The user may interact with this media and this leads to a finish step 1316. It should be understood that this may be part or a full game. Additionally or alternatively, this may be part or all of a school assignment. Additionally or alternatively the cascaded object-related content provision may be part of a college assignment for receiving a course grade or credit.

Some non-limiting examples for title enhancement on title objects includes that when an object is detected, the system is operative to upload one or more of an augmented video, multiple markers/buttons on the detected object, a popup menu, 3D markers, an animation, a sound when the object is detected, such as to play a movie sound when a movie image is detected and marker or popup menu is displayed. Additionally or alternatively, a Facebook “like” icon will be uploaded, which enables: pressing the ‘marker” to activate a Facebook like. Additional social features and signs may be uploaded.

When a title object is detected, one or more media pieces may be played, such as, but not limited to a video, a text/pdf file, weblinks, a Youtube link, an MP3 background image, which when the audio is being played, a background image is provided and/or a slideshow, which will change every few seconds. This is a very useful feature for museums, which have a lot of audio content and want to use on mobile device with a display. Additionally or alternatively, a slide show may be played, talkbacks and crowd discussions may be operative, languages support may be provided to display the media in a selected language, and media may be downloaded to a device and saved locally.

After the object-associated media has been played, a historical log of the media in the title history, including the detected object may be saved or cataloged.

Additionally or alternatively, a click-to-buy icon may be activated after media has been played and a click-to-buy link may be activated.

A change marker may be activated after detection of the object and the media has been played. The change will be marked by the marker, which will appear different at the next detection thereof.

After the object-associated media has been played, a timing event mechanism may be activated, such as a need to find a next item within x seconds. Additionally or alternatively, various texts, images or videos may be displayed on the display screen.

When a user is trying to locate an object location, some location hints may be displayed on the device display, including text or image layers on the objects when the user is in the location area of the object. This may enable the user and or a provider to verify that the object was detected in the correct location.

A user location can be defined by GPS data of his device and can provide the user with at least one direction to the user of where he/she should go to. Additionally or alternatively, there may be a social aspect, such as providing a user and friend location their relative on a map, displayed on their display on each of their devices.

Some non-limiting examples for title enhancement on a whole title objects include, but are not limited to, an image detection check list, a puzzle image such that when an item is detected, part of the image reveals a coupon for use by the user, a game such as a treasure hunt game, a quest game, in which one or more users collect items and use them to solve riddles, the user can download titles according to his/her location, a map of travel, post-visit summaries, including displaying the entire objects detected and display the relevant media, associated therewith and a secret wall for user communicating with his/her friends.

A title comprises one or more of a title icon, information, a set of objects images, objects features data, sounds, sounds features data, movements, movements features data and multimedia expression data. A multimedia expression data comprises audio and video data. The video and audio data comprise media files and/or internet url (uniform resource locator), the address of a web page on a world wide web) address.

Each title comprises one or more of the following components: a title name, a title icon, a title description, a long title description, title info, search keywords, one or more title web links (homepage, youtube, twitter, wikipedia, url's), a title images collage, images features data, resources (list of resources such as media, video, images and html), a title location, title actions, a quest game (structure), title information and title objects.

Each object may comprise one or more of the following: a set of images, each image contains a name, a description, an autoplay command and an ordered/shuffle command, a location accuracy indicator, and optional further actions.

The object feature data is used by the application of the present invention for the local image search.

One use of the application of the present invention is in a quest game. The application of the present invention is constructed and configured to provide a user with a title on his mobile device. The title is operative to add a logic scheme at the level of a title, such as in a treasure hunt, a location. Each trackable/object is constructed to provide the user with an action scheme which enhanced the capabilities.

The title is constructed and configured to have a list of resource file list that will include video, audio, images and the like. These are to be used by the Title logic and actions. This will also include the Local HTML supporting file.

Title actions are a set of actions that are managed at the title level. For example, display buttons, change target cross, display contextual help, social buttons and the like.

Title information includes information on the title and the experience that will be displayed on the mobile device, including icons, description, sample images and media and the like. The system has a display of the title information before downloading to the device, and additional information after downloading to the device.

The geographical location of a user device can be received from the device's GPS/3G/WiFi.

A title location includes a location of the area, such as a city or local area. A trackable location includes an accurate location of a trackable area. These include the use of a point and radius for location coordinates.

An action is an operation or action to be performed by the user or by the device.

Each trackable/object has an action list that is to be performed during detection, during media play and after the media played and may be location based.

The action structure comprises at least one trigger, each trigger associated with one or more of the following: upon detection, upon media play, after media play, and a location-based trigger.

Each trigger may activate one or more of a resource list: video, audio, image, text (message box, display on screen) and an augmented reality expression.

Each action operation comprises one or more of the following properties screen coordinates, a duration, a language, a user profile.

Each trigger may further activate one or more of: an augmented reality expression, a popup menu, a marker (2d, 3d, animation), buttons, augmented video, an animation, a slideshow, a background image, a message box, an audio play, a display image, a display text, a log, a Facebook like, a change marker, a location, and a show marker.

Each object may activate one or more media, such as, but not limited to, a list of medias located at a resource, an audio files local on the device, an audio streaming from the network, a video file local on the device, a video streaming form the network, a Youtube link, an image web link, an image (jpeg, png), a webpage, a local webpages (on the device) a pdf local on the device and a slideshow.

A treasure hunt is one of many different types of games which can have one or more players who try to find hidden articles, locations or places by using a series of clues. (Wikipedia).

The objects of quests require great exertion on the part of the hero, and the overcoming of many obstacles, typically including much travel. The hero normally aims to obtain something or someone by the quest, and with this object to return home. The object can be something new, that fulfills a lack in his life, or something that was stolen away from him or someone with authority to dispatch him. (Wikipedia)

A treasure hunt may include selecting a story, use genre such as detective, ghosts, a ghost theme can be very good for castles game. The game can be linear or non-linear. A treasure hunt is a list of ordered trackables/objects. The player will have to detect the trackables in the correct order to get the media of the trackable.

A typical game flow may include the following parts: a) an introduction screen—text/video/audio on the game and the story. This may include a few screens; b) a treasure hunt game; c) a vision clue/hint will be displayed to help with the trackable search. There may be few clues in a list that can be change when touching it (use arrow); d) upon object detection, the system is operative to perform at least one of the following: play a sound, display markers, note user activity-by pressing marker/menu or autoplay icons, upload media (video, audio, html5), add to inventory, upload an inventory action, provide an after media play, save a history of a detected object, display a next clue on the device display, upload a game end and display a coupon or puzzle/media reward.

When a trackable is detected and is not in the current trackable search, a message will be displayed or a sound will be played. The trackable media is not played until it is detected in the correct order of the treasure hunt list. Trackables that were already detected—their media will be enabled to be played. A history record of detection during the lifetime of the App will be kept by returning to a main page and back to a camera screen, which does not reset the treasure hunt stage.

Game Configuration of the treasure hunt includes selecting a character such as a Prince/Princess/Sailor/Detective. A user interface of the game on the user device includes a camera display and displays one or more of the following on the display: a target cross/ghost detector/magnifying glass, a compass, one or more on-screen clues, a button for help, a button for receiving a game introduction and game rules, a button for diary tasks, a button for detection history/puzzle, a button for inventory, a button for receiving a map, a button for talkback, a camera button for taking pictures, and a help button, which opens a clue/or interactions for each image in the story/introduction.

The introduction play button is operative to upload an introduction screen on the game and the story to the user device display.

A diary task may include the introduction and inventory. There may be diary tasks (game notebook), which will include the game introductions, map/history that will show some of the medias/markers/clues and the inventory tab with all tools. Detection history/puzzle, which are operative to show the progress according to the objects found, Add an item list/puzzle that will be mark (or puzzle revel) each time an object is detected.

An inventory is defined as a collection of items. A map is a progress map according to the detected objects, which will show the path of the story on the user device display and will display the player current point at the game. The game may have associated talkbacks including online crowd discussions, a correct/wrong answer screen, and a game completed screen, which may provide the user with a coupon.

The game may also include title information, including before download (visit)—information on the game and post visit—displaying a winning award, pictures taken, and a game location. The integration of a game location will enable addition of compass capabilities and direction clues.

Tables 2-3 show various implementations of a game flows in accordance with some embodiments of the present invention:

TABLE 2
Steps of a treasure hunt game flow.

| Step | | Description |
|---|---|---|
| 1. | A0 | Introduction page |
| 2. | A0 | Game rules page |
| 3. | A0 | Story page |
| 4. | A1 | Clue on Camera screen |
| 5. | TA1 | Trackable detected - sound |
| 6. | TA1 | Trackable detected - Marker |
| 7. | TA1 | Play media |
| 8. | TA1 | Next Clue on Camera screen |
| 9. | TA2 | Trackable detected - sound |
| 10. | TA2 | Trackable detected - Marker |
| 11. | TA2 | Question |
| 12. | TA2 | Wrong Answer |
| 13. | TA2 | Right Answer - Play media |
| 14. | TA2 | Next Clue on Camera screen |
| . . . | . . . | . . . |

TABLE 3
Steps of a linear treasure hunt within a location:

| Step | | Description |
|---|---|---|
| 1. | A0 | Introduction page |
| 2. | A1 | Clue on Camera screen |
| 3. | L1 | Direction clue on camera screen |
| 4. | L1 | Direction clue on camera screen - |
| | | Closer to object |
| 5. | TA1 | Trackable detected - sound |
| 6. | TA1 | Trackable detected - Marker |
| 7. | TA1 | Play media |
| 8. | TA1 | Next Clue on Camera screen |

A Quest game structure may comprise a treasure hunt game, with a logic flow as in one of the tables. This may be stored in the system in the title database. The structure may comprise of a logs into the system with user name (Facebook/Google), an introduction actions, a list of objects and their associated actions. There may also be time-associated actions. A game completion actions and a list of actions to handle various scenarios such as an image detected, before detection, but not in the current image search or actions for image detected, after detection, but not in the current image search.

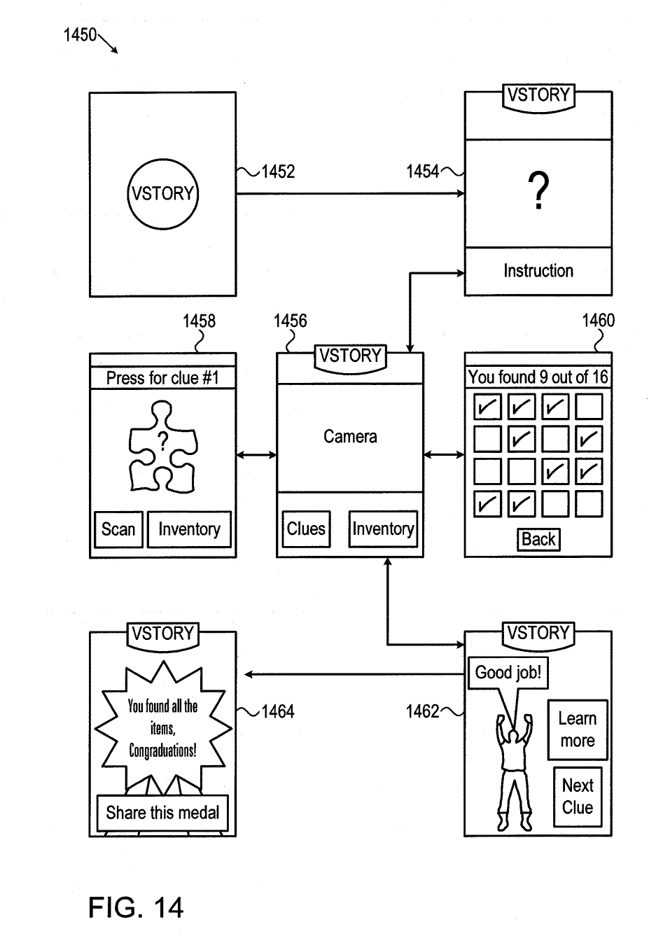

Reference is now made to FIG. 14, which is a simplified pictorial illustration 1450 of a sequence of events in playing a game on a device using enhanced cascaded object-related content provision, in accordance with an embodiment of the present invention. Step 1452 graphically represents the start of a game. In step 1454, instructions on how to play the game can be uploaded. This may include a few screen shots with video, text, illustrations and the like.

In upload camera step 1456, a camera screen is uploaded and this displays the augmented expression of a detected object.

Display step 1460 is a screen shot comprising the game history check boxes, thereby displaying objects, which were already detected (labeled with a tick or pin and those which the user has yet to detect.

Display step 1458 is a clue displaying step in which a clue for an object, which needs to be detected is displayed. This can also take the form of a diary with the information regarding the objects and the clues.

In display step 1462, when an object of the game is detected, the display shows a response to the user for a correct detection or for an error. It may also display media (video, audio, text, web, animation, other and combinations thereof).

In the last display step 1464, when the user has found all objects in the game and these were detected on the device screen, then an upload of a success screen is provided to the user, This may be a coupon or any other reward.

Many games and experiences can be played based on the enhanced cascaded object-related content provision, few more examples:

Hints for trackable location logic when an accurate location input is available, the application searches for the trackable that the location coordinates are within the trackable area. Thereafter, the trackable location action will be activated. It may show a hint.

History check box/puzzle-add an item list/puzzle that will be mark (or puzzle revel) each time an object is detected. Each detected object will be saved in title history information. When displaying the checkbox/puzzle, the application will use the history information to display the matching items.

An example is that on the camera screen there will be a button on the screen, touching the button will open a Puzzle screen that will reveal the puzzle parts that are related to the detected objects. If all the objects were detected, then the puzzle will be fully revealed. This can be for example a coupon or a reference to purchase in a store.

Title location on a map-on the titles search screen, the titles can be displayed in a map view, where the user location is centered and all the titles with a location are displayed with the correct distance and coordinates from the user location.

Download of the next multimedia content-when detecting an object and playing its multimedia expression, the cascade action may download additional multimedia content and augmented reality expressions that are related to the detected object, which are related to nearby objects and other common multimedia content that is going to be played in the near future.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A method for enhanced cascaded personalized object-related content provision, the method comprising:
a) detecting an object with a multimedia communication device;
b) uploading content related to the detected object to said device to enable a user to perform at least one user action; and
c) providing further content associated with said detected object responsive to said at least one user action, and wherein said personalized object-related content is personalized in accordance with at least one of a user profile and a user location.

2. A method according to claim 1, wherein said enhanced cascade object-related content provision is responsive to detecting said object.

3. A method according to claim 1, wherein said enhanced cascade object-related content provision is responsive to a location of said device.

4. A method according to claim 1, wherein said enhanced cascade object-related content provision is responsive to two user actions.

5. A method according to claim 4, wherein said enhanced cascade object-related content provision is responsive to three user actions.

6. A method according to claim 1, wherein the enhanced cascade object-related content provision is provided according to a predefined sequence.

7. A method according to claim 6, wherein said predefined sequence is associated with at least one of the detected object, a location of the device and a user characteristic.

8. A method according to claim 1, wherein said personalized object-related content is filtered according to said user profile.

9. A method according to claim 8, wherein said content is generated automatically.

10. A method according to claim 9, wherein said content is uploaded according to age, motion, location, GPS, etc. or the content can be user-selected, such as, but not limited to, text-based, videos, augmented reality, text-to-speech, or based upon the user's personal request or interest.

11. A method according to claim 10, wherein said content matches a language of said user.

12. A system for enhanced cascaded object-related content provision, the system comprising:
a. a communication network;
b. a processor; and
c. a multimedia communication device adapted to detect an object and to upload content to a display on said device related to the detected object to enable a user to perform at least one user action, wherein said device is further adapted to provide further content associated with said detected object responsive to said at least one user action.

13. A system according to claim 12, wherein said processor is adapted to:
a) generate content associated with an object and to store the content in a database; and
b) dynamically adjust the content associated with the object according to at least one of a user profile and user location to form a user-defined object-based content package;

14. A system according to claim 13, wherein said multimedia communication device further comprises:
i. an optical element adapted to capture a plurality of images of captured objects;
ii. a processing device adapted to;
1. activate an object recognition algorithm to detect at least one detected object from the plurality of images of captured objects by performing a local search and a networked search for the at least one object simultaneously;
2. download at least one of local content and networked content to form a downloaded multimedia package; and
iii. a display adapted to display at least one captured image of the identified object(s) and provide at least one of user-defined object-based content and the downloaded multimedia package.

15. A computer software product, the product configured for enhanced cascaded object-related content provision, the product including a computer-readable medium in which program instructions are stored, which instructions, when read by a computer, cause the computer to;
i. detect an object with a multimedia communication device;
ii. upload content related to the detected object to said device to enable a user to perform at least one user action; and
iii. provide further content associated with said detected object responsive to said at least one user action.

16. A computer software product according to claim 15, wherein said product is further adapted to:
iv. generate networked content associated with an object to form a storable networked content package associated with the object;
v. capture a plurality of images of captured objects;
vi. activate an object recognition algorithm to detect at least one identified object from the plurality of images of captured objects by performing a local search and a networked search for the at least one object simultaneously; and
vii. download a detected-object multimedia package including least one of local content and the networked content package associated with the detected object(s).
